(19) United States
(12) Patent Application Publication
(10) Pub. No.: US 2025/0138849 A1
(43) Pub. Date: May 1, 2025

(54) USER INTERFACE FOR ANALYTICS CONTROL

(71) Applicant: Kinaxis Inc., Ottawa (CA)

(72) Inventors: Hariram RAVICHANDRAN, Chennai (IN); Jamuthira RAMAKRISHNAN, Chennai (IN); Praveen GANGADHARAN, Chennai (IN); Santhosh ALAGAN, Chennai (IN); Karthikeyan VIJAYAN, Chennai (IN); Pugalendran SOLAIMOORTHY, Chennai (IN)

(21) Appl. No.: 18/923,264

(22) Filed: Oct. 22, 2024

Related U.S. Application Data
(60) Provisional application No. 63/593,048, filed on Oct. 25, 2023.

(51) Int. Cl. G06F 9/451

(52) U.S. Cl. CPC G06F 9/451

(57) ABSTRACT

Systems and methods that provide a user interface, that comprises a central worksheet, through which disparate locations are accessed. In addition, such a user interface allows for enablement and/or disablement of an algorithm in just one or two clicks (as opposed to the tens, scores or hundreds of clicks required before).

The present application claims the benefit of U.S. Provisional Patent Application No. 63/593,048 filed Oct. 25, 2023, which is entirely herein by reference.

### BACKGROUND

Analytics control setups are scattered in multiple locations, which means that a user must navigate through multiple touches in order to make changes. This process can often be a time-consuming, and/or can lead to inaccurate configuration settings.

A challenging task in conventional methods of analytics control is remembering the various tables and fields that were used to control the analytics and updating them according to various requirements. It is difficult to find various tables and sources in order to update values; often one must read manuals to understand how to navigate to the appropriate information.

In addition, there is a lack of transparency around which analytics are being used in a platform. Also, there are often many limitations and conflicts that can arise when trying to use multiple analytics.

As part of an analysis, there may be a need to enable or disable an algorithm. Currently, multiple steps are required to do that. That is, analytics control setups are scattered in multiple places, so a user must perform multiple touches in order to make the changes. A user is required to perform multiple steps, access multiple worksheets, and perform multiple navigations.

### BRIEF SUMMARY

Disclosed herein are systems and methods that provide a centralized view, or user interface, that comprises a central worksheet, through which disparate locations are accessed. In addition, such a user interface allows for enablement and/or disablement of an algorithm in just one or two clicks (as opposed to the tens, scores or hundreds of clicks required before).

Systems and methods disclosed herein result in increased efficiency, while addressing limitations and conflicts that arise once the analytics are enabled or disabled. The centralized control set up is more efficient and effective as its reduces the number of touches and avoids toggling between workbooks.

In one aspect, a system includes a processor. The system also includes a memory storing instructions that, when executed by the processor, configure the system to create, by the processor, one or more table-based base worksheets for each analytic, build, by the processor, a composite worksheet by combining all of the table-based base worksheets, create, by the processor, a new custom table with one or more requisite fields, update, by the processor, the composite worksheet, create, by the processor, a lookup worksheet, create, by the processor, a respective modification worksheet for each analytic, add, by the processor, all of the modification worksheets, create, by the processor, a respective drill-to-detail worksheet for each analytic, render, by the processor, each drill-to-detail worksheet conditionally hidden, add, by the processor, all of the conditionally-hidden drill-to-detail worksheets, create, by the processor, an action button to hide one or more detailed worksheets, create, by the processor, a limitations-count worksheet, count, by the processor, a number of limitations associated with each analytic, create, by the processor, a limitations worksheet, add, by the processor, the limitations worksheet to the composite worksheet, create, by the processor, a conflicts-count worksheet, count, by the processor, a number of conflicts associated with each analytic, create, by the processor, a conflicts worksheet, and add, by the processor, the conflicts worksheet to the composite worksheet.

The system may also include where the lookup worksheet is created by grouping data. The system may also include where all of the modification worksheets are added in a single Run command. The system may also include where the limitations-count worksheet is created by applying one or more filter conditions. The system may also include where the conflicts-count worksheet is created by applying one or more filter conditions. The system may also include where when counting the number of limitations associated with each analytic, the system is further configured to take, by the processor, a composite of the limitations-count worksheet, and enable, by the processor, summarization for a count column. The system may also include where when counting the number of conflicts associated with each analytic, the system is further configured to take, by the processor, a composite of the conflicts-count worksheet, and enable, by the processor, summarization for a count column. Other technical features may be readily apparent to one skilled in the art from the following figures, descriptions, and claims.

In one aspect, a non-transitory computer-readable storage medium, the computer-readable storage medium including instructions that when executed by a computer, cause the computer to create, by a processor, one or more table-based base worksheets for each analytic, build, by the processor, a composite worksheet by combining all of the table-based base worksheets, create, by the processor, a new custom table with one or more requisite fields, update, by the processor, the composite worksheet, create, by the processor, a lookup worksheet, create, by the processor, a respective modification worksheet for each analytic, add, by the processor, all of the modification worksheets, create, by the processor, a respective drill-to-detail worksheet for each analytic, render, by the processor, each drill-to-detail worksheet conditionally hidden, add, by the processor, all of the conditionally-hidden drill-to-detail worksheets, create, by the processor, an action button to hide one or more detailed worksheets, create, by the processor, a limitations-count worksheet, count, by the processor, a number of limitations associated with each analytic, create, by the processor, a limitations worksheet, add, by the processor, the limitations worksheet to the composite worksheet, create, by the processor, a conflicts-count worksheet, count, by the processor, a number of conflicts associated with each analytic, create, by the processor, a conflicts worksheet, and add, by the processor, the conflicts worksheet to the composite worksheet.

The non-transitory computer-readable storage medium may also include where the lookup worksheet is created by grouping data. The non-transitory computer-readable storage medium may also include where all of the modification worksheets are added in a single Run command. The non-transitory computer-readable storage medium may also include where the limitations-count worksheet is created by applying one or more filter conditions. The non-transitory computer-readable storage medium may also include where the conflicts-count worksheet is created by applying one or more filter conditions. The non-transitory computer-readable storage medium may also include where when counting the number of limitations associated with each analytic, the computer is further configured to take, by the processor, a composite of the limitations-count worksheet, and enable, by the processor, summarization for a count column. The non-transitory computer-readable storage medium may also include where when counting the number of conflicts associated with each analytic, the computer is further configured to take, by the processor, a composite of the conflicts-count worksheet, and enable, by the processor, summarization for a count column. Other technical features may be readily apparent to one skilled in the art from the following figures, descriptions, and claims.

In one aspect, a computer-implemented method for constructing a user interface, the method includes: creating, by a processor, one or more table-based base worksheets for each analytic, building, by the processor, a composite worksheet by combining all of the table-based base worksheets, creating, by the processor, a new custom table with one or more requisite fields, updating, by the processor, the composite worksheet, creating, by the processor, a lookup worksheet, creating, by the processor, a respective modification worksheet for each analytic, adding, by the processor, all of the modification worksheets, creating, by the processor, a respective drill-to-detail worksheet for each analytic, rendering, by the processor, each drill-to-detail worksheet conditionally hidden, adding, by the processor, all of the conditionally-hidden drill-to-detail worksheets, creating, by the processor, an action button to hide one or more detailed worksheets, creating, by the processor, a limitations-count worksheet, counting, by the processor, a number of limitations associated with each analytic, creating, by the processor, a limitations worksheet, adding, by the processor, the limitations worksheet to the composite worksheet, creating, by the processor, a conflicts-count worksheet, counting, by the processor, a number of conflicts associated with each analytic, creating, by the processor, a conflicts worksheet, and adding, by the processor, the conflicts worksheet to the composite worksheet.

The computer-implemented method may also include where the lookup worksheet is created by grouping data. The computer-implemented method may also include where all of the modification worksheets are added in a single Run command. The computer-implemented method may also include where the limitations-count worksheet is created by applying one or more filter conditions. The computer-implemented method may also include where the conflicts-count worksheet is created by applying one or more filter conditions. The computer-implemented method may also include where when counting the number of limitations associated with each analytic, the method further includes taking, by the processor, a composite of the limitations-count worksheet, and enabling, by the processor, summarization for a count column. The computer-implemented method may also include where when counting the number of conflicts associated with each analytic, the method further includes taking, by the processor, a composite of the conflicts-count worksheet, and enabling, by the processor, summarization for a count column. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system in accordance with one embodiment.

FIG. 2A illustrates a first part of a block diagram in accordance with one embodiment.

FIG. 2B illustrates continuation of the block diagram shown in FIG. 2A, in accordance with one embodiment.

FIG. 2C illustrates continuation of the block diagram shown in FIG. 2B, in accordance with one embodiment.

FIG. 3A illustrates a first part of Table and Field details, in accordance with one embodiment.

FIG. 3B illustrates a continuation of the Table and Field details, in accordance with one embodiment.

FIG. 3C illustrates a continuation of the Table and Field details, in accordance with one embodiment.

FIG. 3D illustrates a continuation of the Table and Field details, in accordance with one embodiment.

FIG. 4 illustrates composite worksheet details in accordance with one embodiment.

FIG. 5 illustrates creation of a new custom table, in accordance with one embodiment.

FIG. 6A illustrates creation of a custom table in accordance with one embodiment.

FIG. 6B illustrates creation of a first field, in accordance with one embodiment.

FIG. 6C illustrates creation of a second field, in accordance with one embodiment.

FIG. 6D illustrates creation of a third field, in accordance with one embodiment.

FIG. 7 illustrates creation of a new worksheet based on a custom table, in accordance with one embodiment.

FIG. 8A illustrates creation of lookup worksheet in accordance with one embodiment.

FIG. 8B illustrates a first part of table that lists modification worksheets, in accordance with one embodiment.

FIG. 8C illustrates a continuation of the table shown in FIG. 8B, in accordance with one embodiment.

FIG. 8D illustrates a continuation of the table shown in FIG. 8C, in accordance with one embodiment.

FIG. 8E illustrates a continuation of the table shown in FIG. 8D, in accordance with one embodiment.

FIG. 8F illustrates a continuation of the table shown in FIG. 8E, in accordance with one embodiment.

FIG. 8G illustrates a continuation of the table shown in FIG. 8F, in accordance with one embodiment.

FIG. 8H illustrates a continuation of the table shown in FIG. 8G, in accordance with one embodiment.

FIG. 9A illustrates modification of worksheets in accordance with one embodiment.

FIG. 9B illustrates saving data changes in a Product Algorithms worksheet in accordance with one embodiment.

FIG. 9C illustrates a first part of table that lists conditionally hidden Drill to Detail worksheets, in accordance with one embodiment.

FIG. 9D illustrates continuation of the table shown in FIG. 9C in accordance with one embodiment.

FIG. 9E illustrates continuation of the table shown in FIG. 9D in accordance with one embodiment.

FIG. 9F illustrates continuation of the table shown in FIG. 9E in accordance with one embodiment.

FIG. 9G illustrates continuation of the table shown in FIG. 9G in accordance with one embodiment.

FIG. 10 illustrates an action button for hiding a visible drill worksheet in accordance with one embodiment.

FIG. 11A illustrates an SRC: Limitation Count Worksheet in accordance with one embodiment.

FIG. 11B illustrates properties of an SRC: Limitation Count Worksheet in accordance with one embodiment.

FIG. 12A illustrates a CMP: Limitation Count Worksheet in accordance with one embodiment.

FIG. 12B properties of a CMP: Limitation Count Worksheet in accordance with one embodiment.

FIG. 13A illustrates an SRC: Conflicts Count Worksheet in accordance with one embodiment.

FIG. 13B illustrates a CMP: Conflicts Count Worksheet in accordance with one embodiment.

FIG. 13C illustrates properties of an SRC: Conflicts Count Worksheet in accordance with one embodiment.

FIG. 14A illustrates a Limitations Worksheet in accordance with one embodiment.

FIG. 14B illustrates properties of a Limitations Worksheet in accordance with one embodiment.

FIG. 15A illustrates a Conflicts Worksheet in accordance with one embodiment.

FIG. 15B illustrates properties of a Conflicts Worksheet in accordance with one embodiment.

FIG. 16A illustrates a User Interface Worksheet in accordance with one embodiment.

FIG. 16B illustrates properties of a User Interface Worksheet in accordance with one embodiment.

FIG. 16C illustrates an aspect of a User Interface Worksheet in accordance with one embodiment.

FIG. 16D illustrates properties of a User Interface Worksheet in accordance with one embodiment.

FIG. 17 illustrates an aspect of a User Interface Worksheet in accordance with one embodiment.

FIG. 18 illustrates an aspect of a User Interface Worksheet in accordance with one embodiment.

FIG. 19 illustrates an aspect of a User Interface Worksheet in accordance with one embodiment.

FIG. 20A illustrates an aspect of a User Interface Worksheet in accordance with one embodiment.

FIG. 20B illustrates a further aspect of the User Interface Worksheet shown in FIG. 20A, in accordance with one embodiment.

FIG. 21 illustrates a block diagram in accordance with one embodiment.

FIG. 22A illustrates a user-interface in accordance with one embodiment.

FIG. 22B illustrates modification of the user-interface shown in FIG. 22A, in accordance with one embodiment.

FIG. 22C illustrates modification of the user-interface shown in FIG. 22A, in accordance with one embodiment.

FIG. 22D illustrates the user-interface shown in FIG. 22C, in accordance with one embodiment.

FIG. 22E illustrates the user-interface shown in FIG. 22C and FIG. 22D, in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

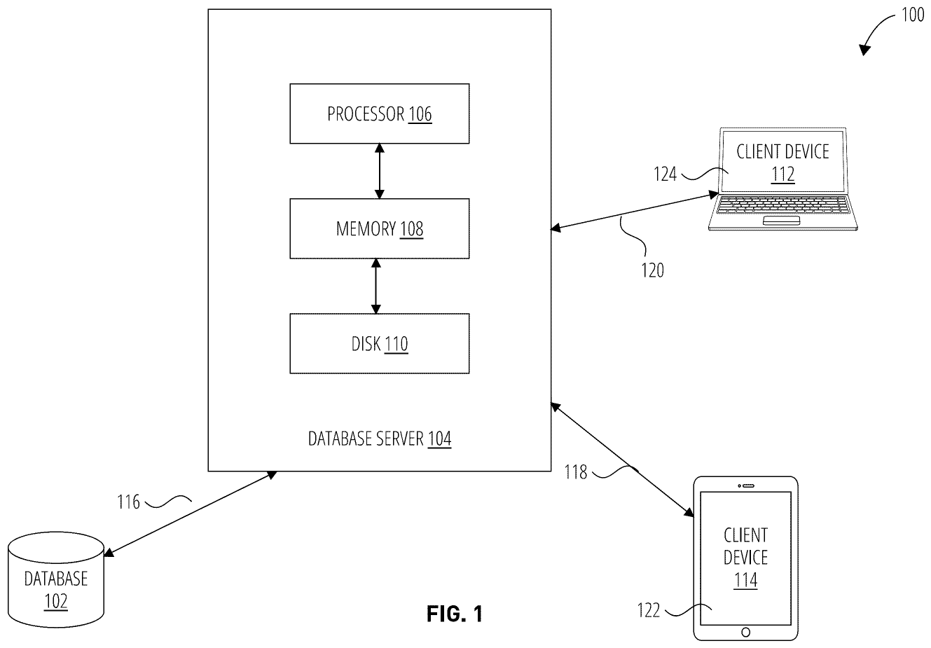

FIG. 1 illustrates an example of a system 100 in accordance with an embodiment.

System 100 includes a database server 104, a database 102, and client devices 112 and 114. Database server 104 can include a memory 108, a disk 110, and one or more processors 106. In some embodiments, memory 108 can be volatile memory, compared with disk 110which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104can then send requested data to client devices 112 and 114 via interfaces 120 and 118, respectively, to be displayed on applications 122 and 124. Applications 122 and 124 can be a web browser or other application running on client devices 112 and 114.

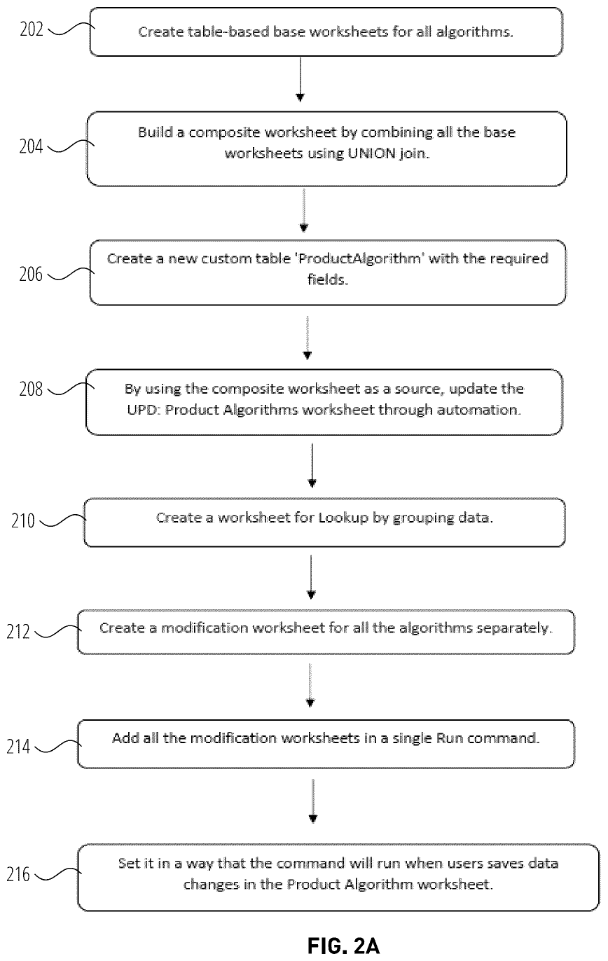

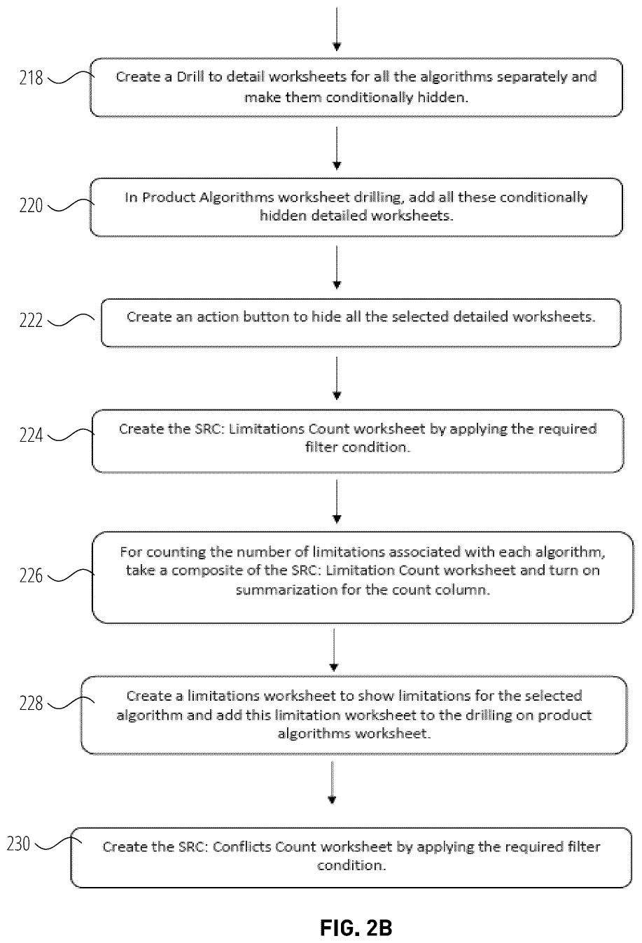

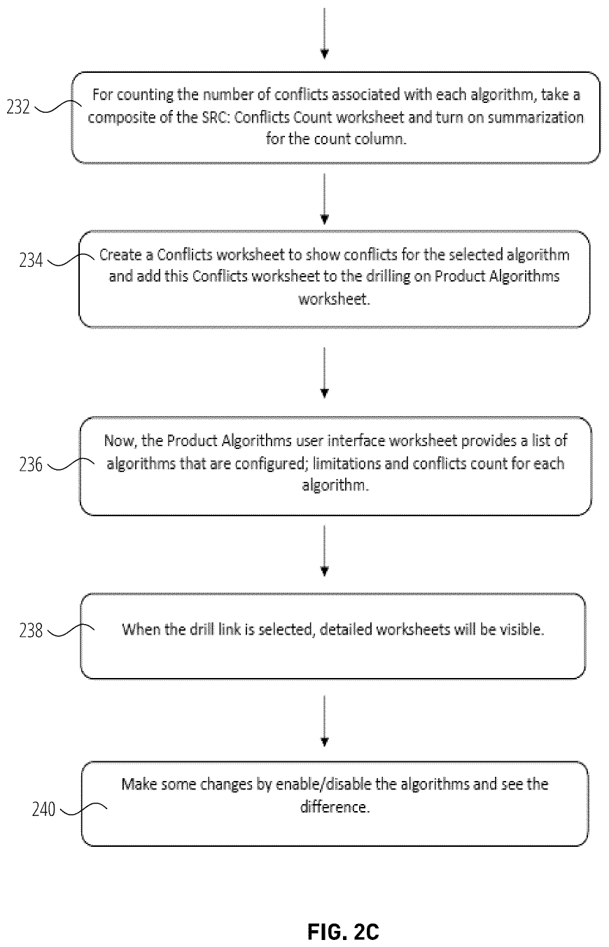

FIG. 2A-FIG. 2C illustrate a block diagram for constructing an analytics control center in accordance with one embodiment.

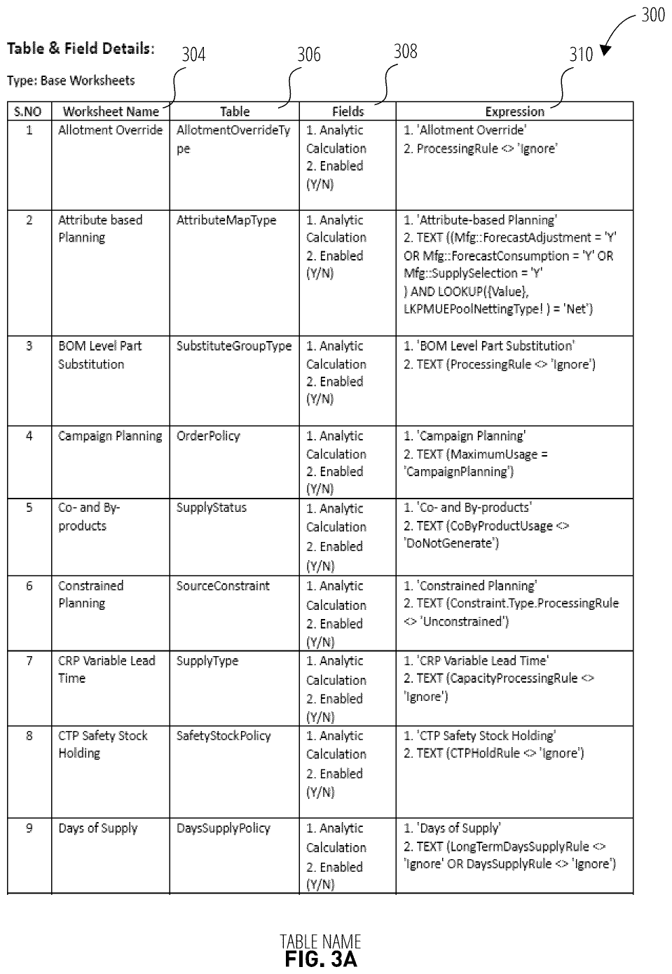

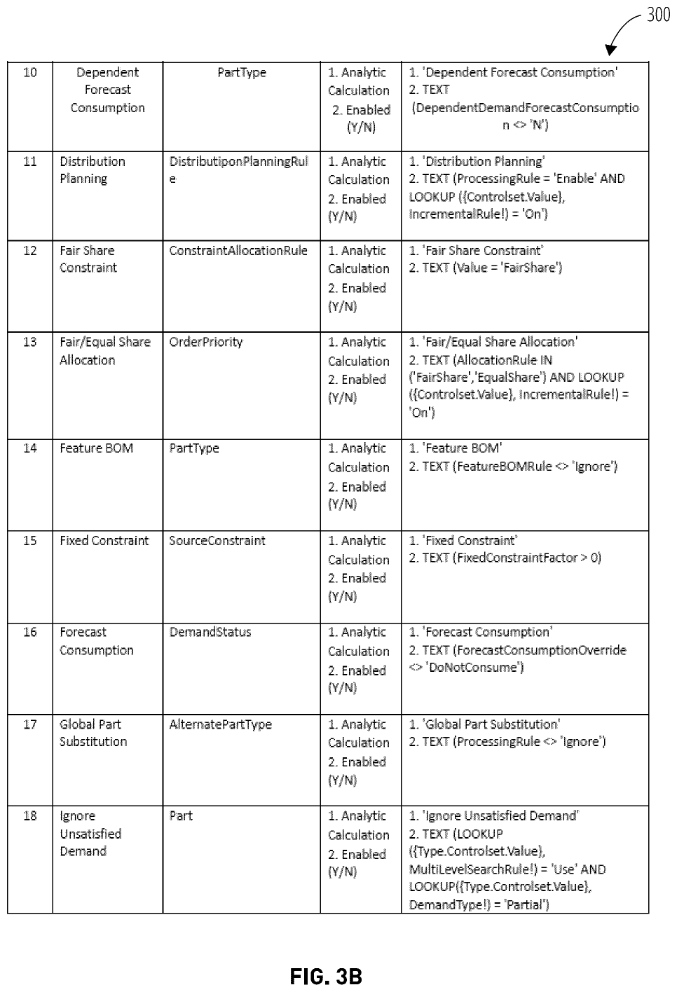

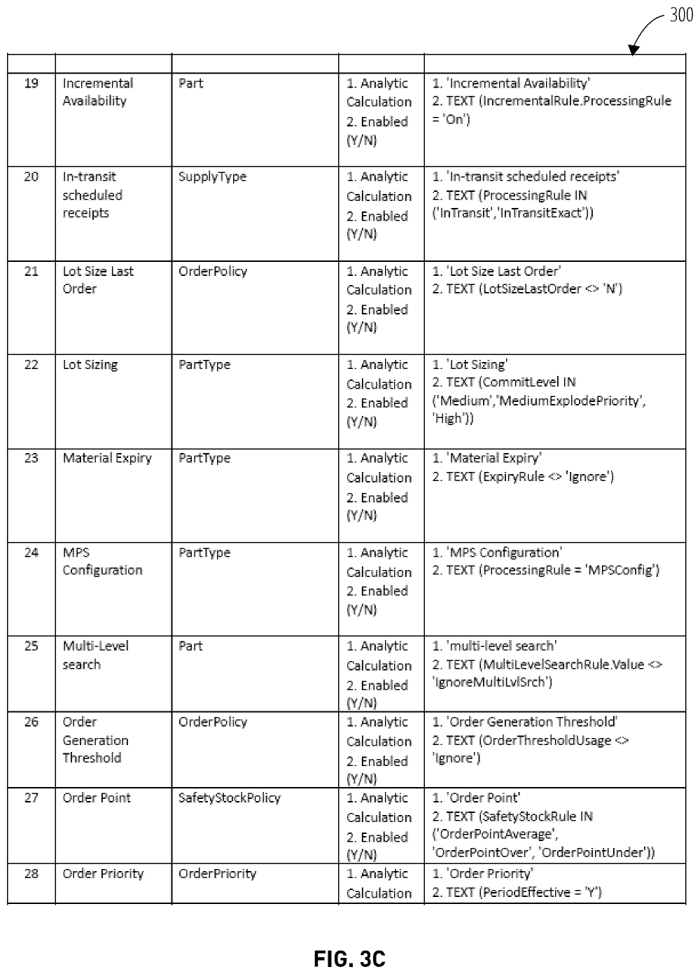

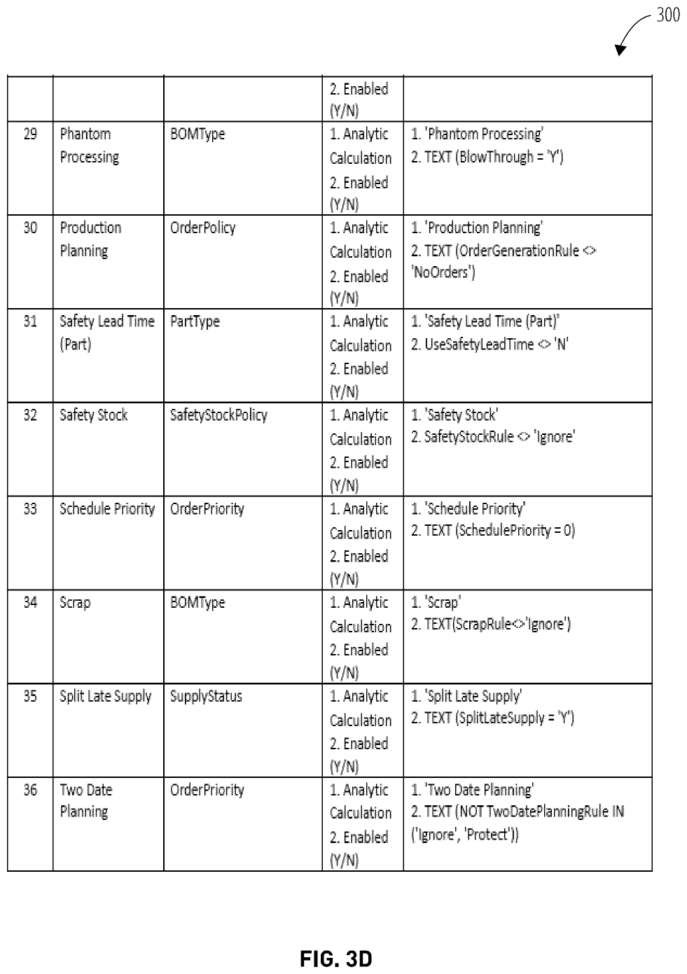

In FIG. 2A, table-based worksheets may be created for all algorithms, at block 202. This is further exemplified in FIG. 3A-FIG. 3D.

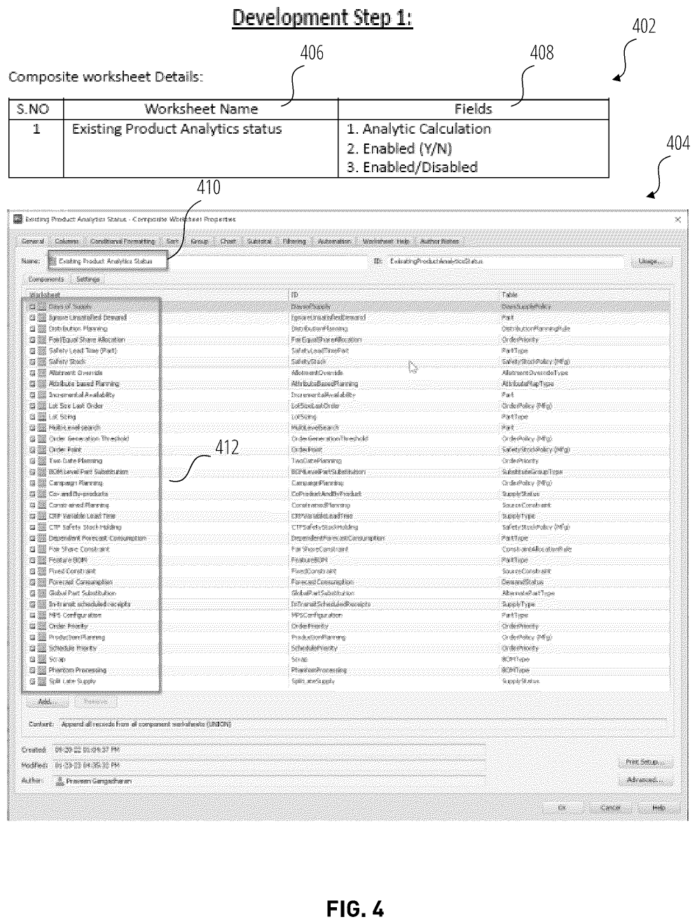

Next, at block 204, a composite worksheet can be built by combining all the base worksheets (created at block 202) using UNION join. This is further elaborated in FIG. 4.

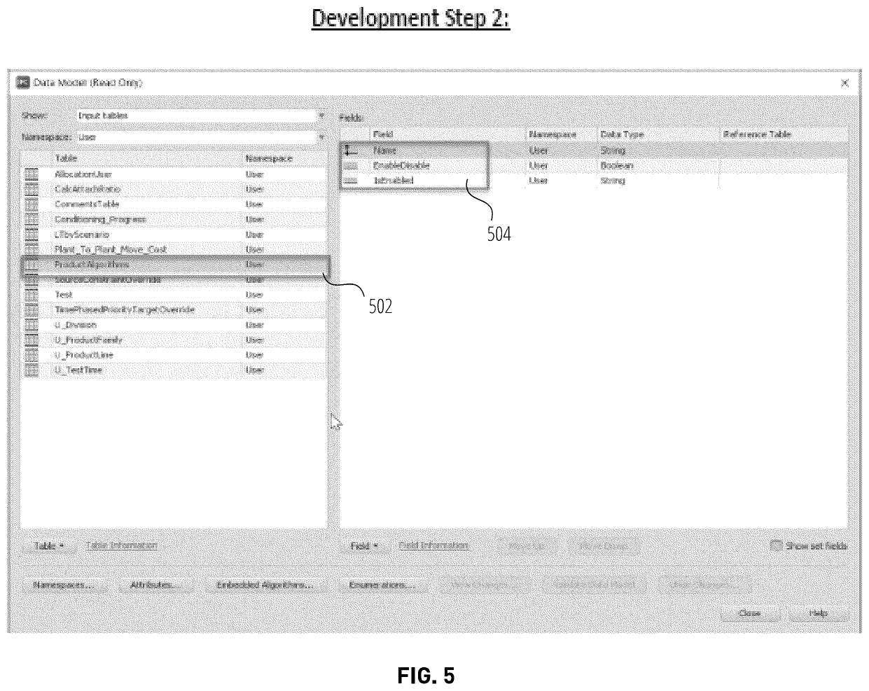

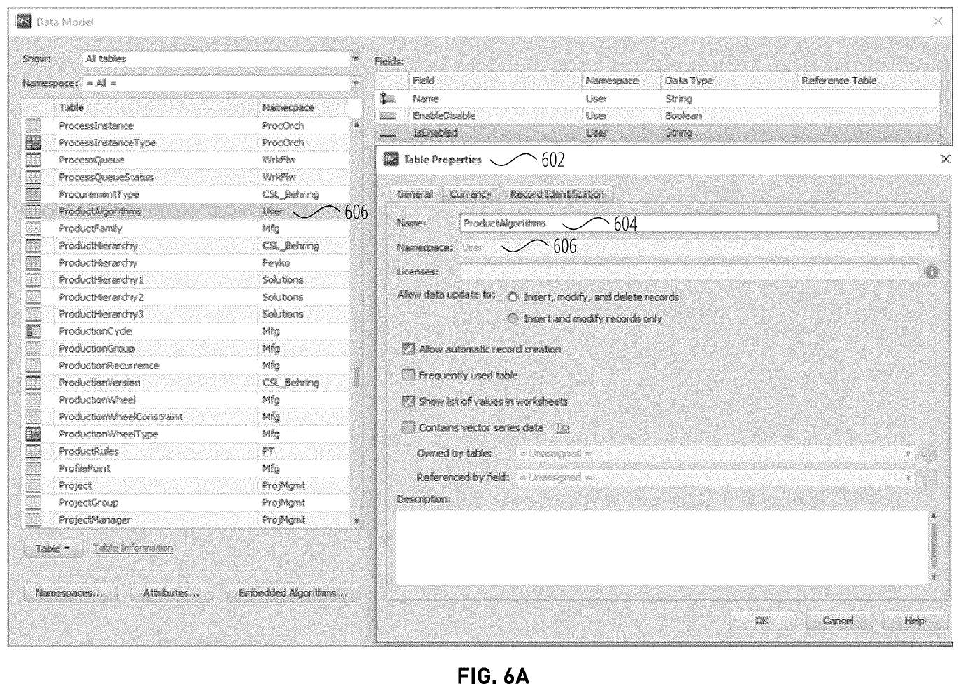

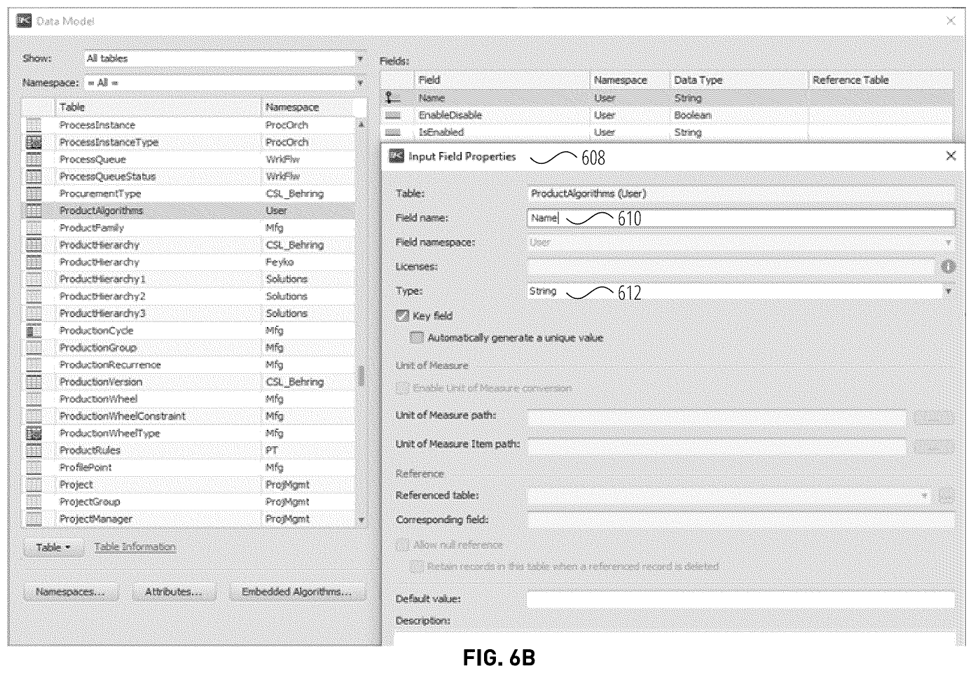

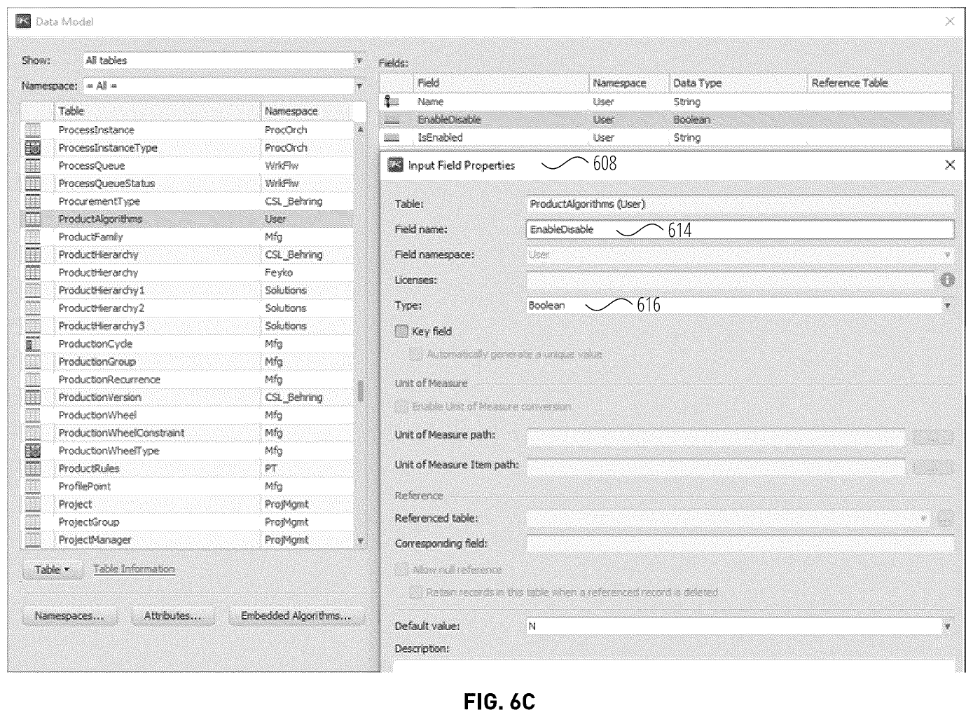

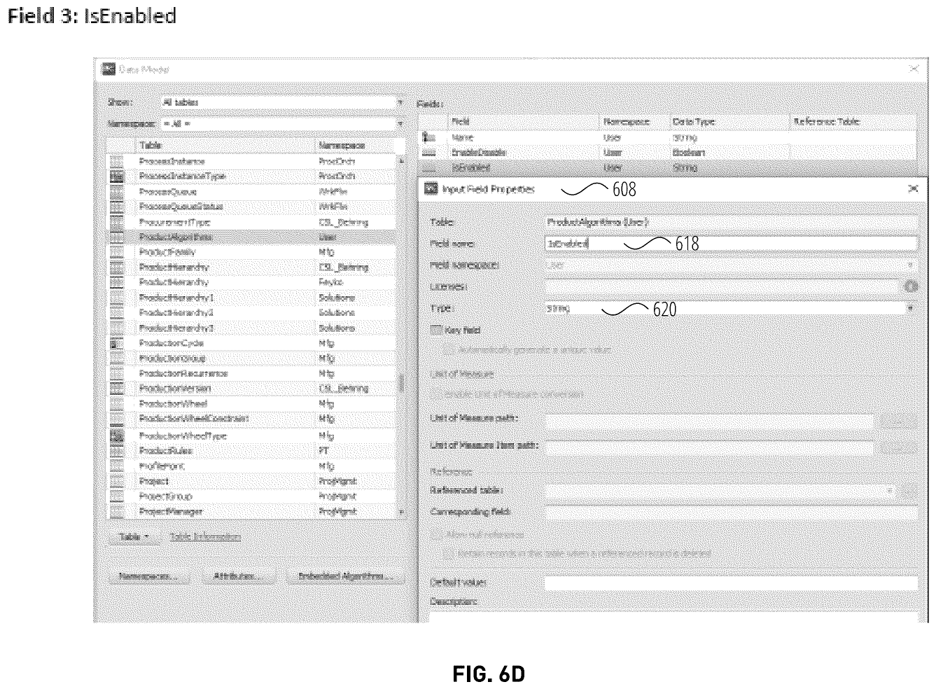

Next, at block 206, a new custom table can be created, along with fields. This is further elaborated in FIG. 5 and FIG. 6A-FIG. 6D. In this example, the custom table is named “Product Algorithm” (although any name can be chosen by a user).

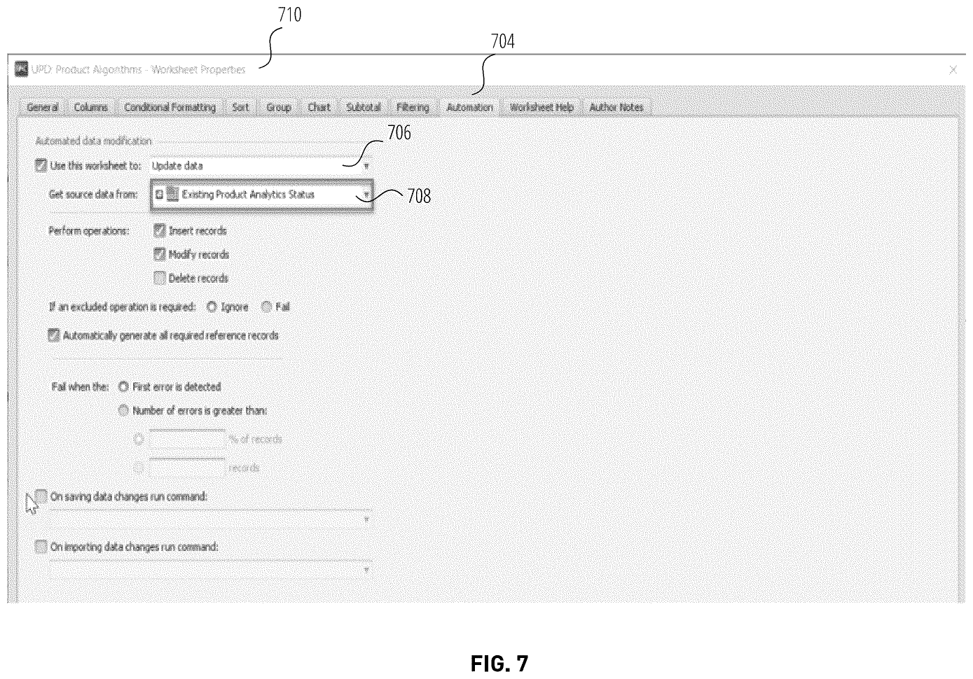

Next, at block 208, by using the composite worksheet, created at block 204, as a source, the UPD: Product Algorithms worksheet may be updated through automation. This is further elaborated in FIG. 7. In this example, the custom table is named “Product Algorithm” (although any name can be chosen by a user).

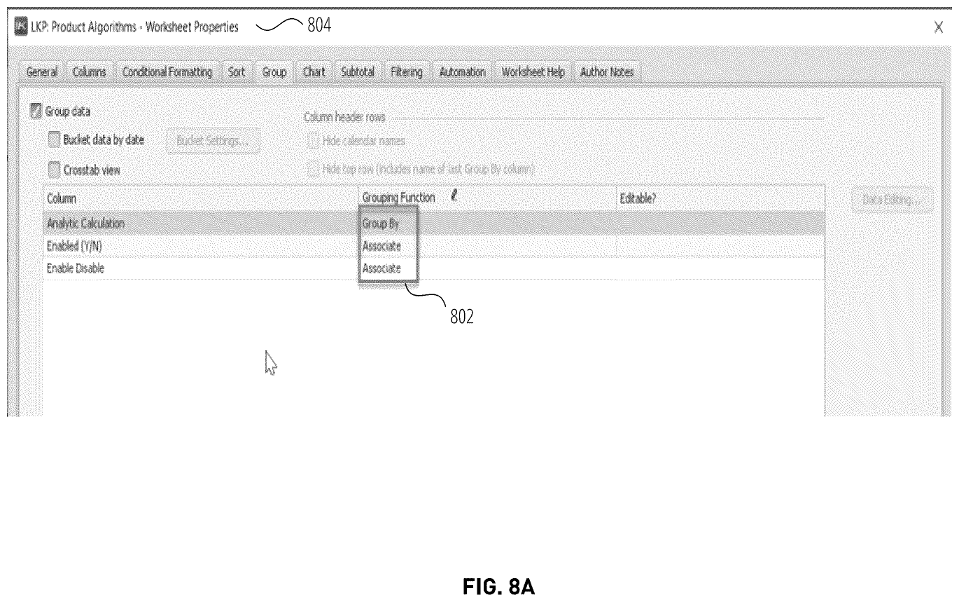

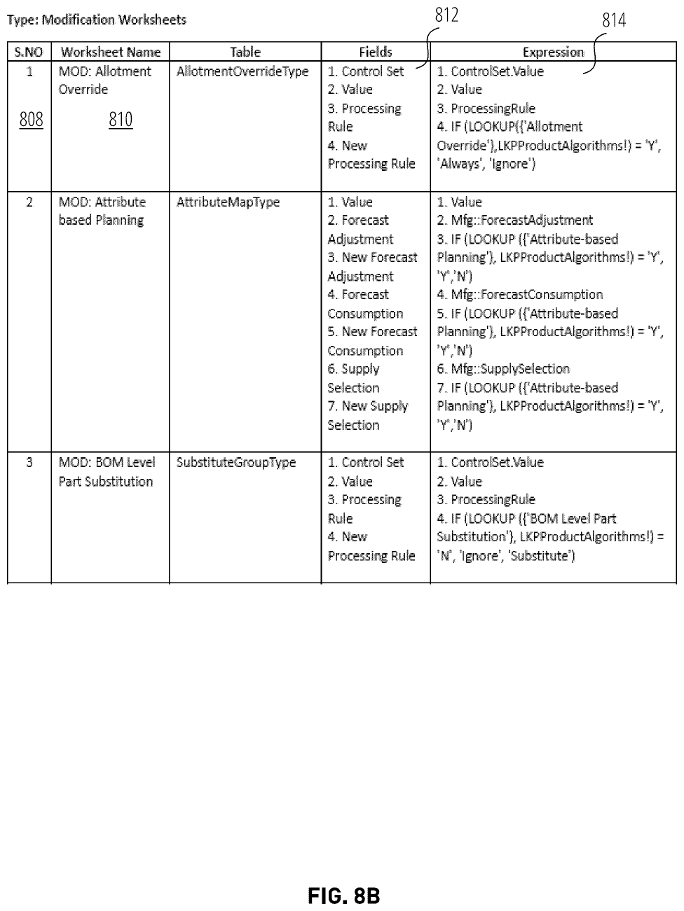

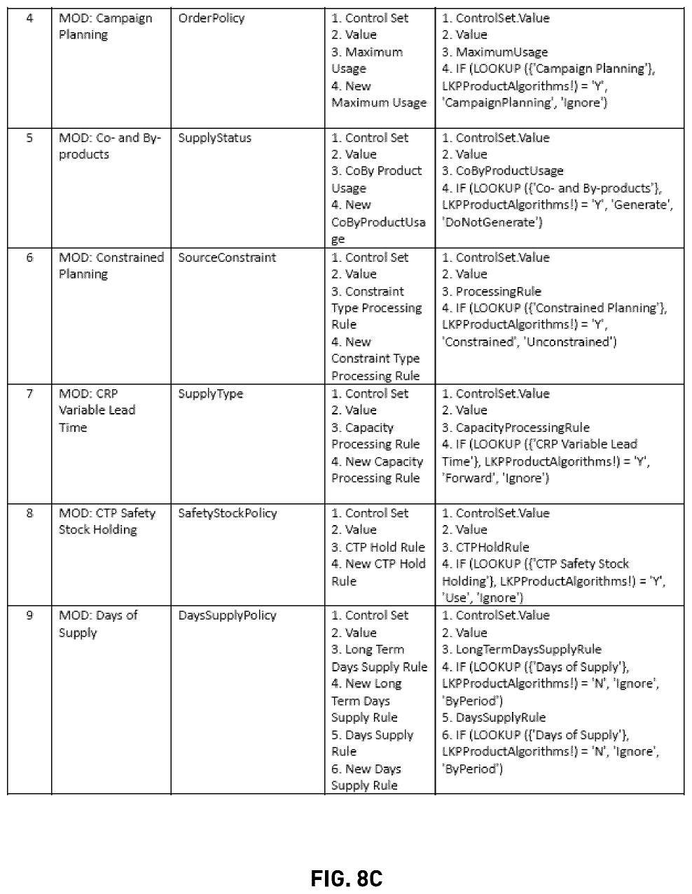

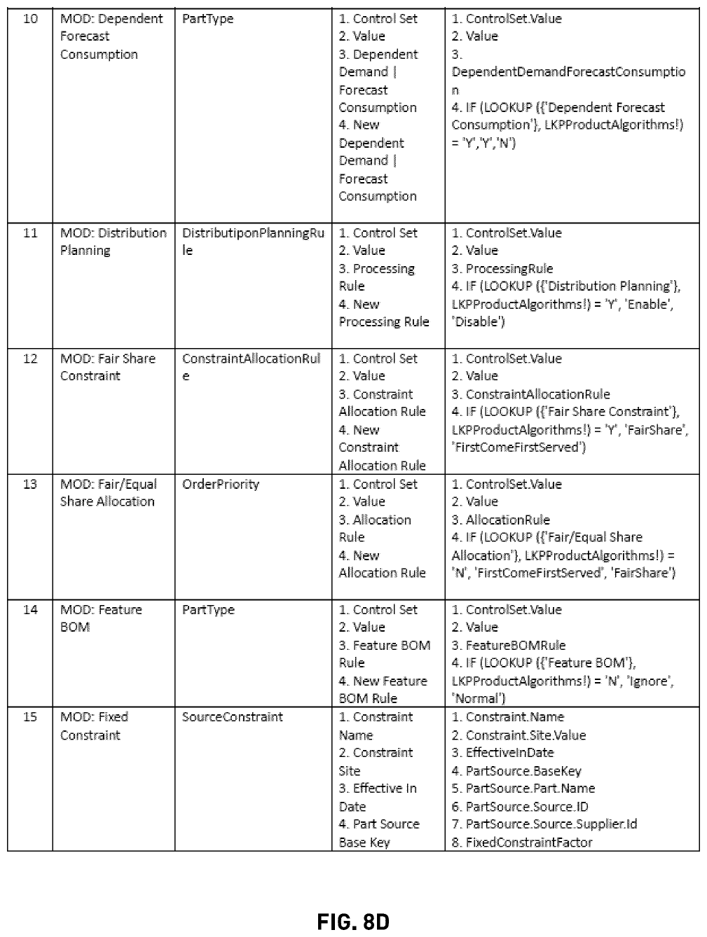

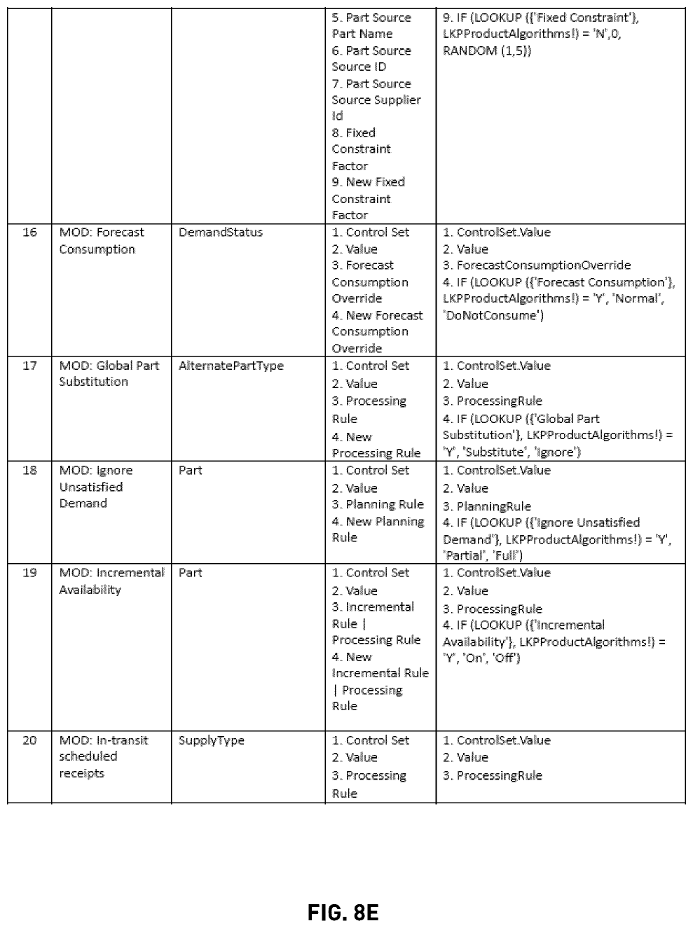

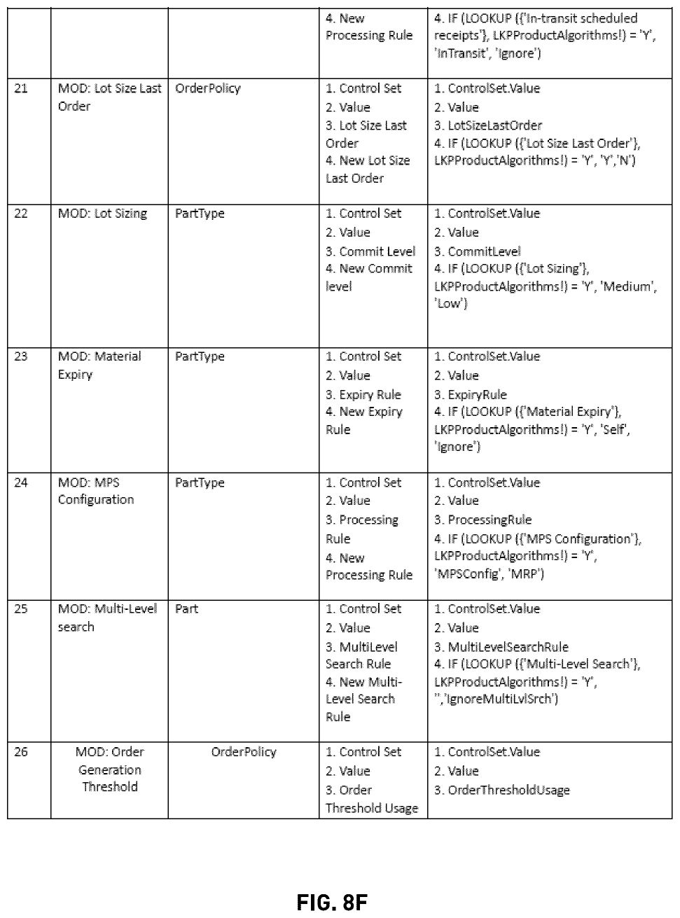

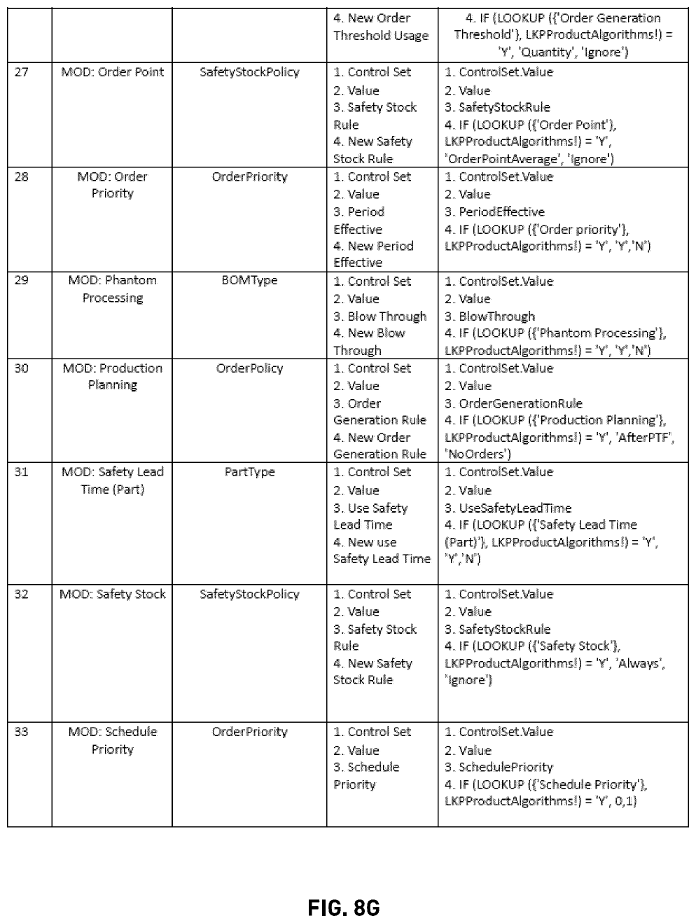

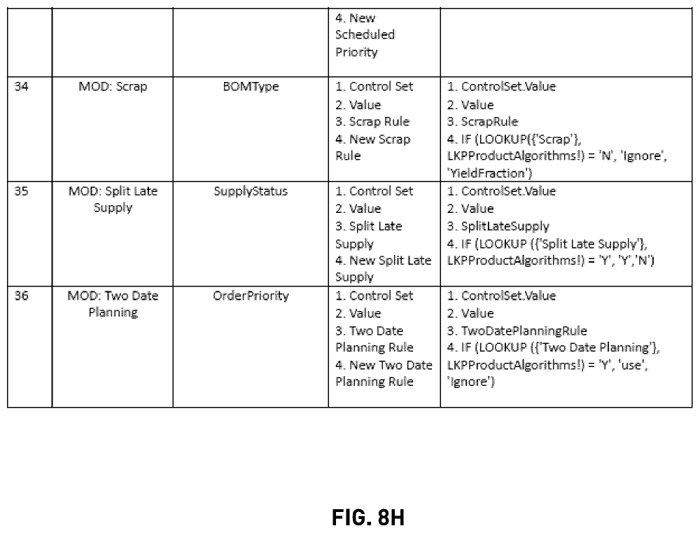

Next, at block 210, a worksheet for Lookup can be created by grouping data. This is further elaborated in FIG. 8A-FIG. 8H.

Next, at block 212, a modification worksheet for all algorithms can be created separately. Next, at block 214, all the modification worksheets may be added in a single Run command. Next, at block 216, the single Run command may be set in way that the command will run when users saves data changes in the Product Algorithm worksheet.

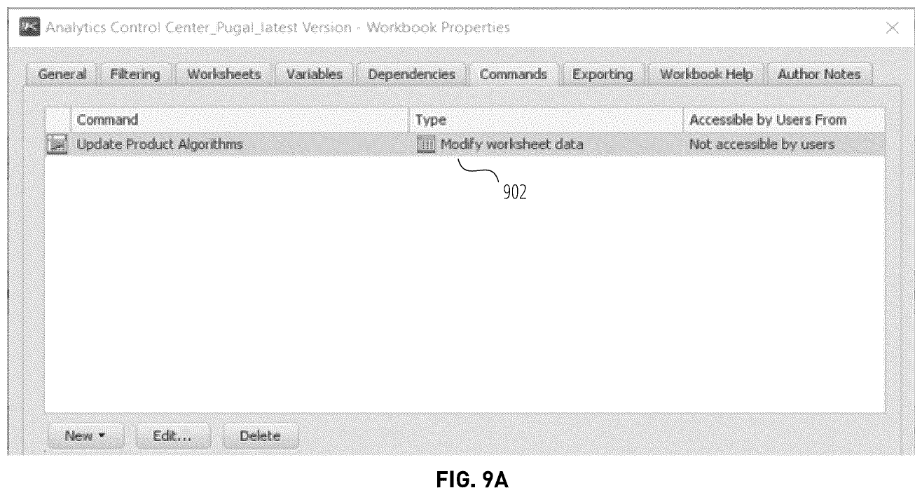

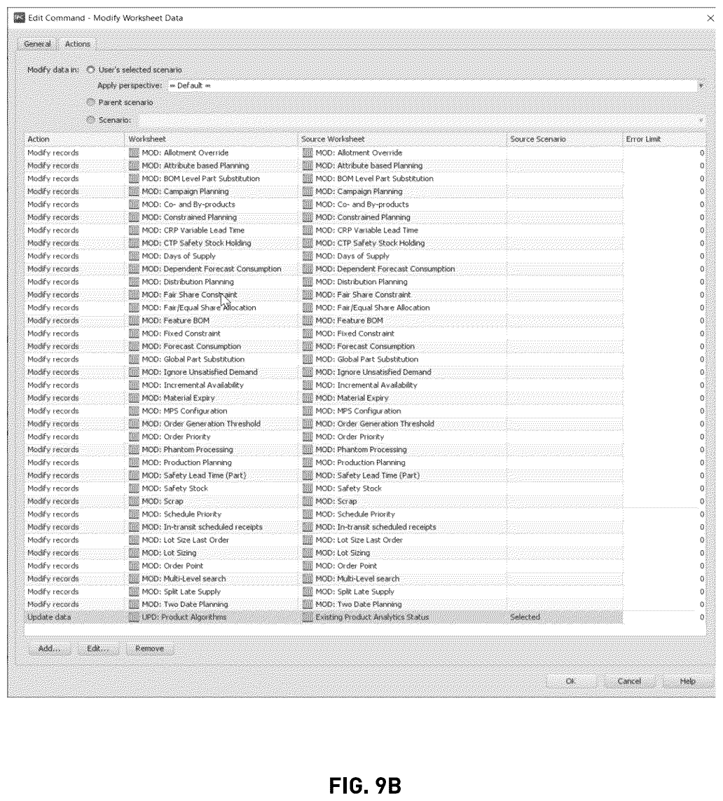

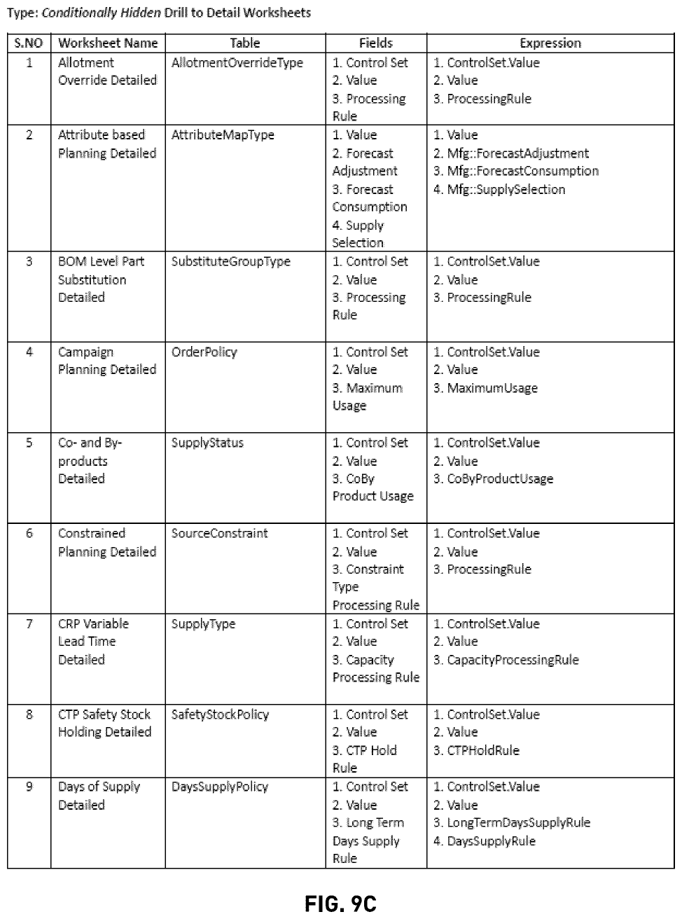

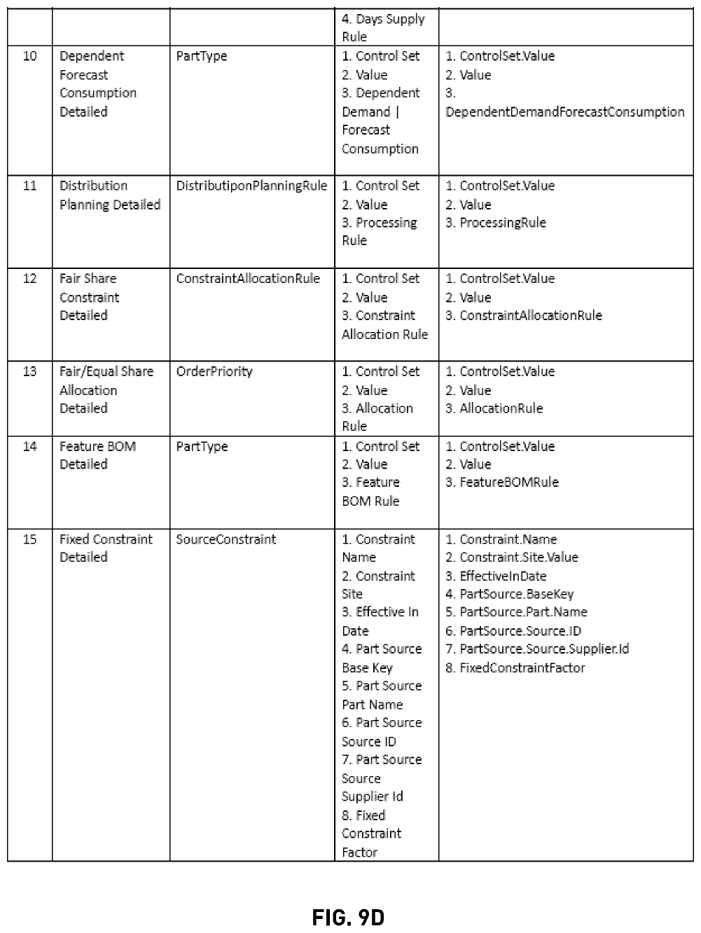

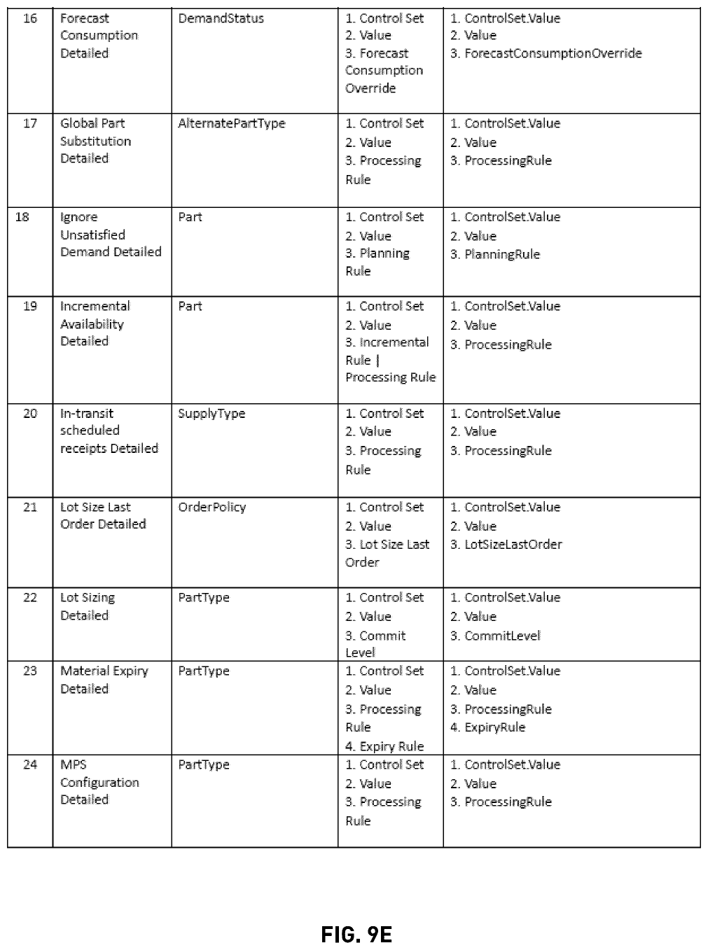

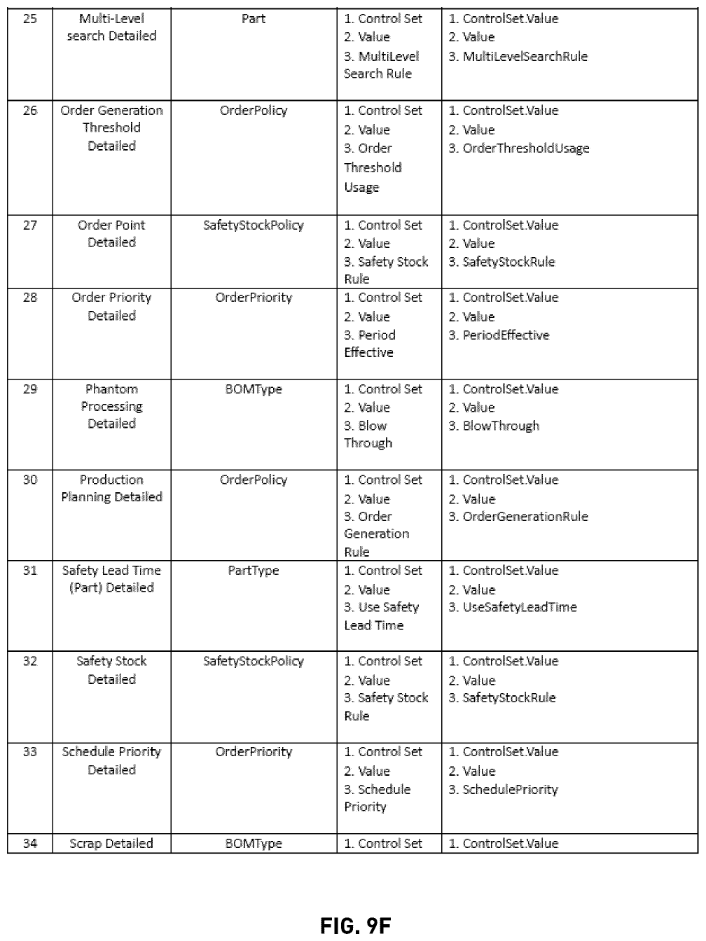

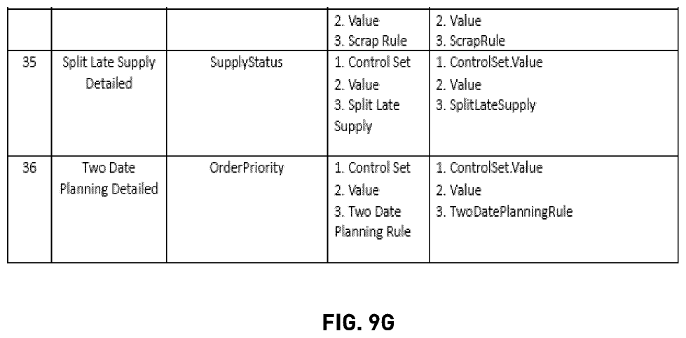

Next, at block 218, Drill to detail worksheets can be created for all the algorithms separately; these can be made conditionally hidden. Next, at block 220, In Product Algorithms worksheet drilling, all conditionally hidden detailed worksheets can be added. Blocks 212-220 are further elaborated in FIG. 9A-FIG. 9G.

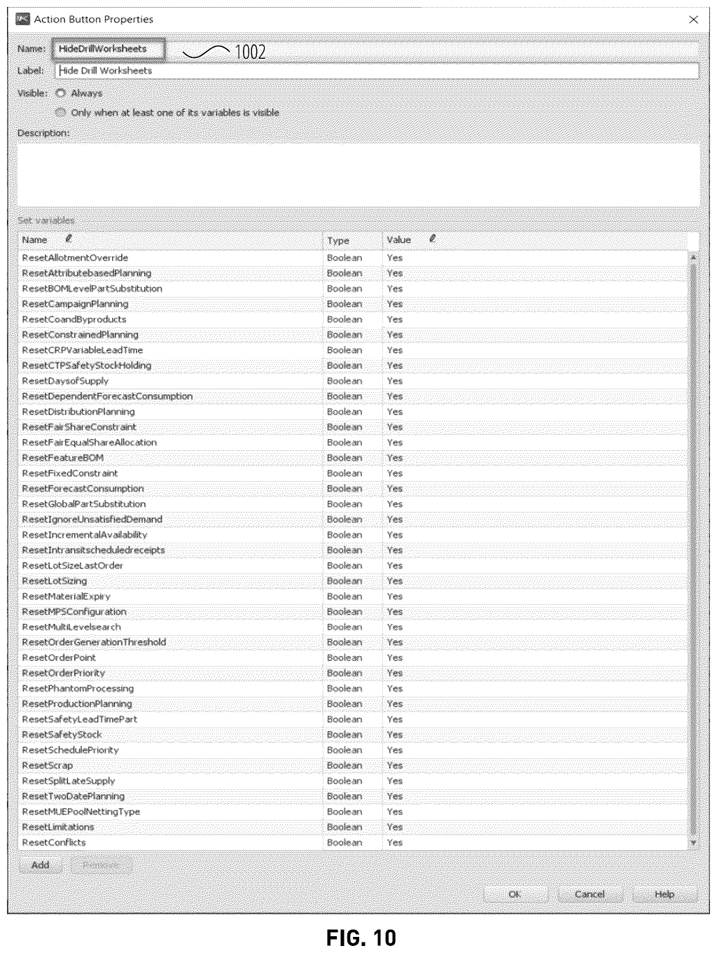

Next, at block 222, an action button may be created to hide all the selected detailed worksheets. This is further elaborated in FIG. 10.

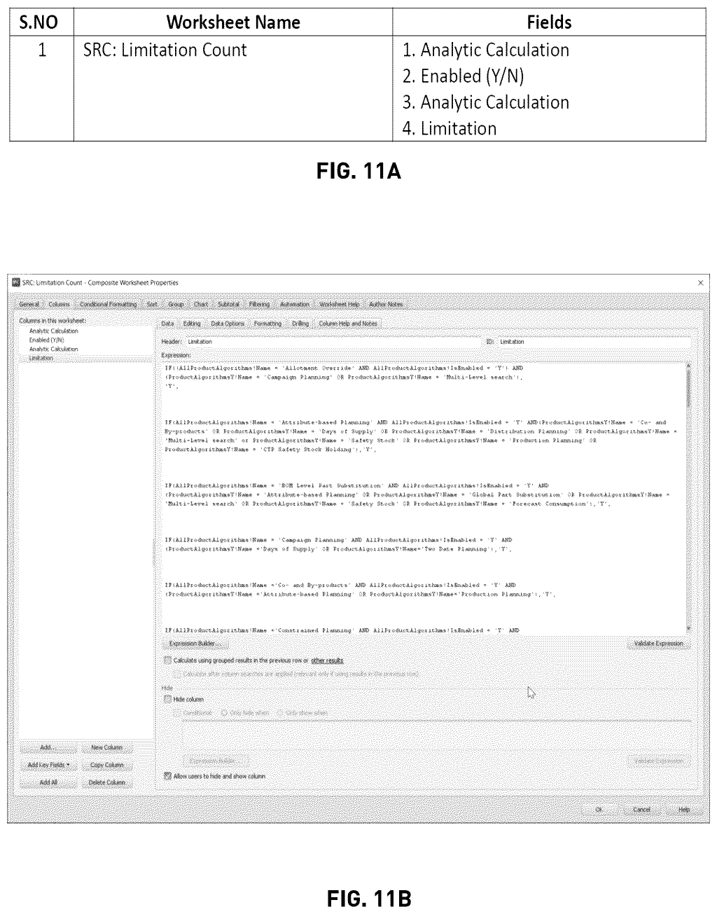

Next, at block 224, an SRC: Limitations Count worksheet can be created by applying the required filter condition. This is further elaborated in FIG. 11A.

Next, at block 226, for counting the number of limitations associated with each algorithm, a composite of the SRC: Limitation Count worksheet can be taken and summarization for the count column may be turned on. This is further elaborated in FIG. 11B.

Next, at block 228, a limitations worksheet can be created to show limitations for the selected algorithm and this limitation worksheet may be added to the drilling on product algorithms worksheet. This is further elaborated in FIG. 14A.

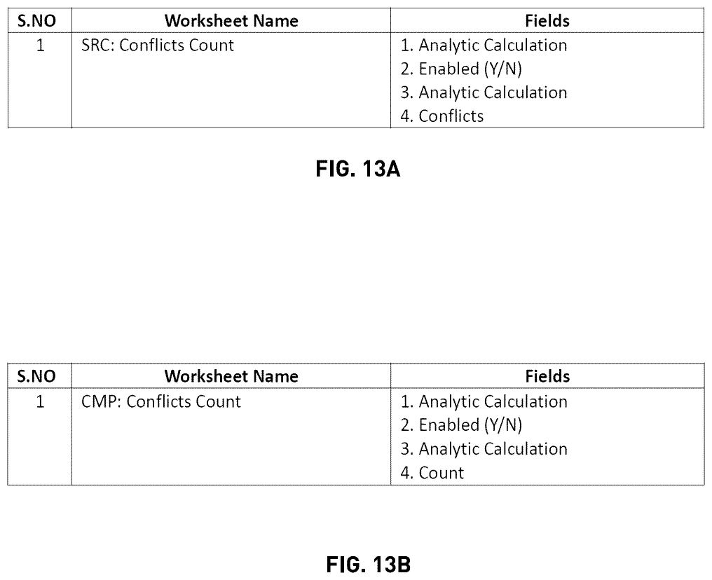

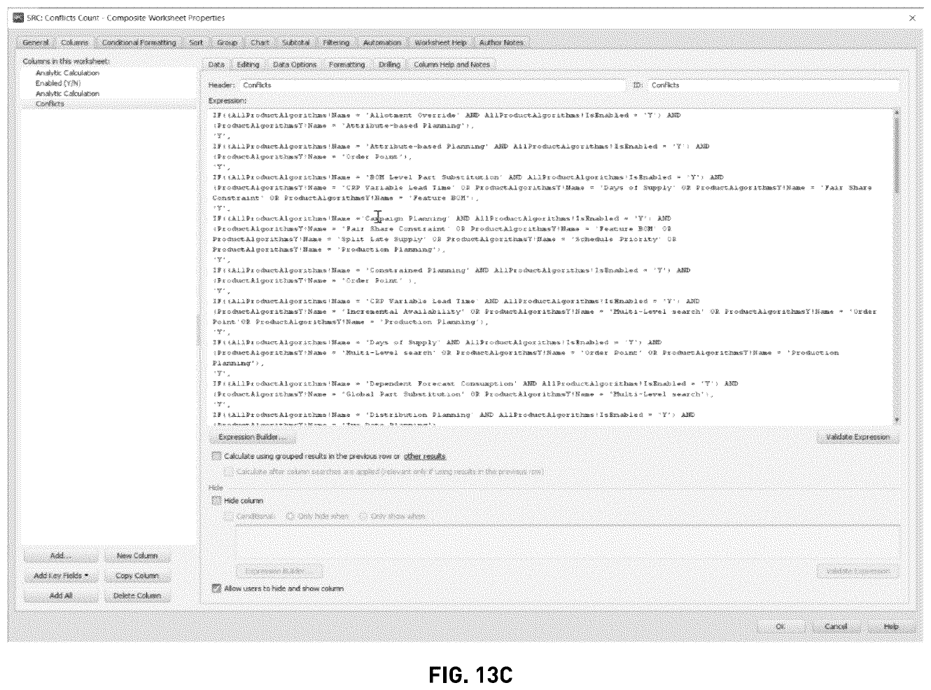

Next, at block 230, an SRC: Conflicts Count worksheet can be created by applying the required filter condition. This is further elaborated in FIG. 13A.

Next, at block 232, for counting the number of conflicts associated with each algorithm, a composite of the SRC: Conflicts Count worksheet may be taken and summarization for the count column can be turned on. This is further elaborated in FIG. 13B and FIG. 13C.

Next, at block 234, a Conflicts worksheet can be created to show conflicts for the selected algorithm. The Conflicts worksheet can be added to the drilling on Product Algorithms worksheet. This is further elaborated in FIG. 14B.

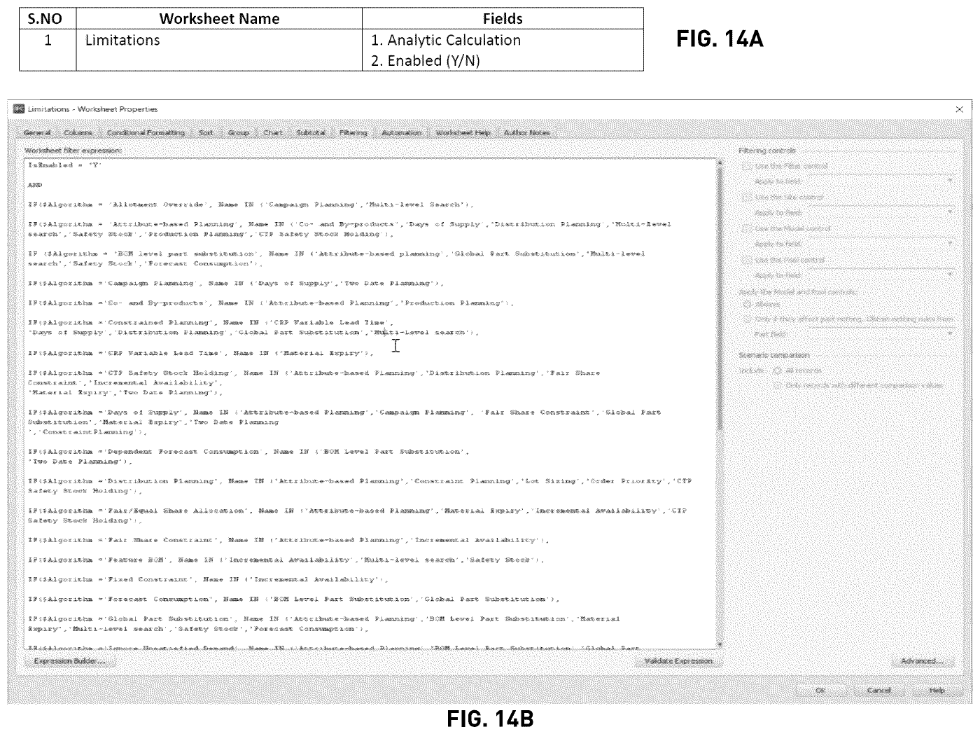

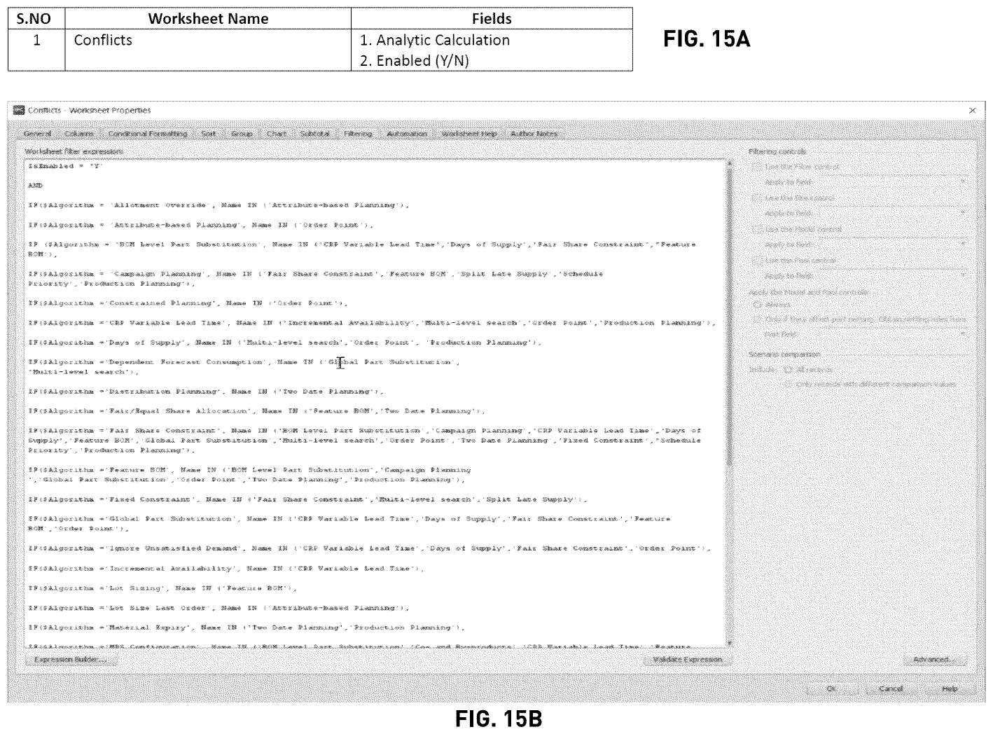

Next, at block 236, the Product Algorithms user interface worksheet can now provide a list of algorithms that are configured, along with a limitations and conflicts count for each algorithm. This is further elaborated in FIG. 15A and FIG. 15B.

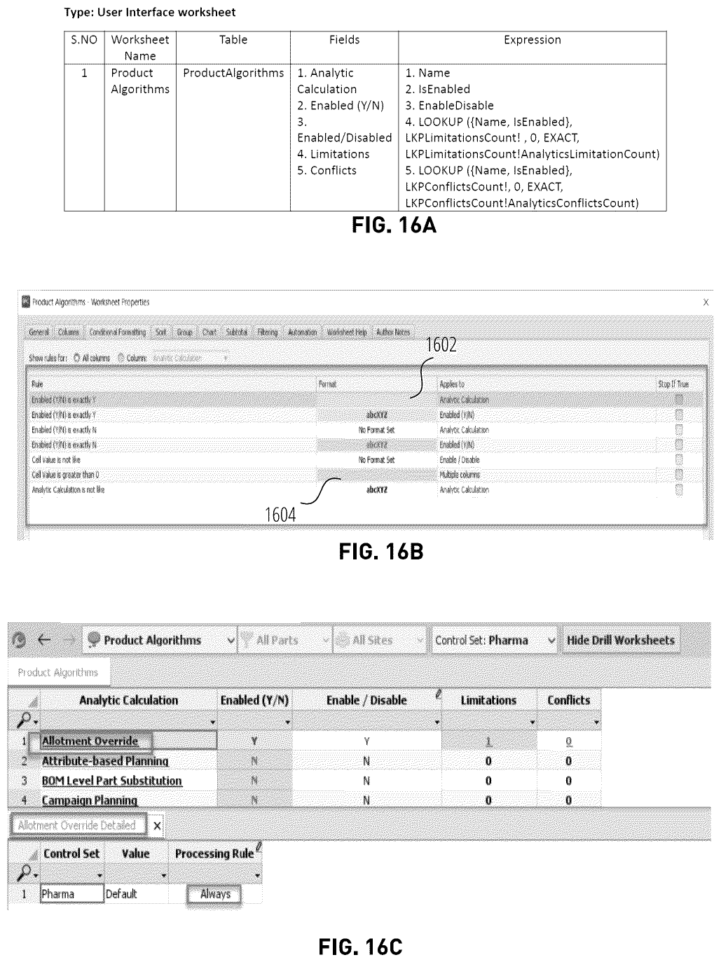

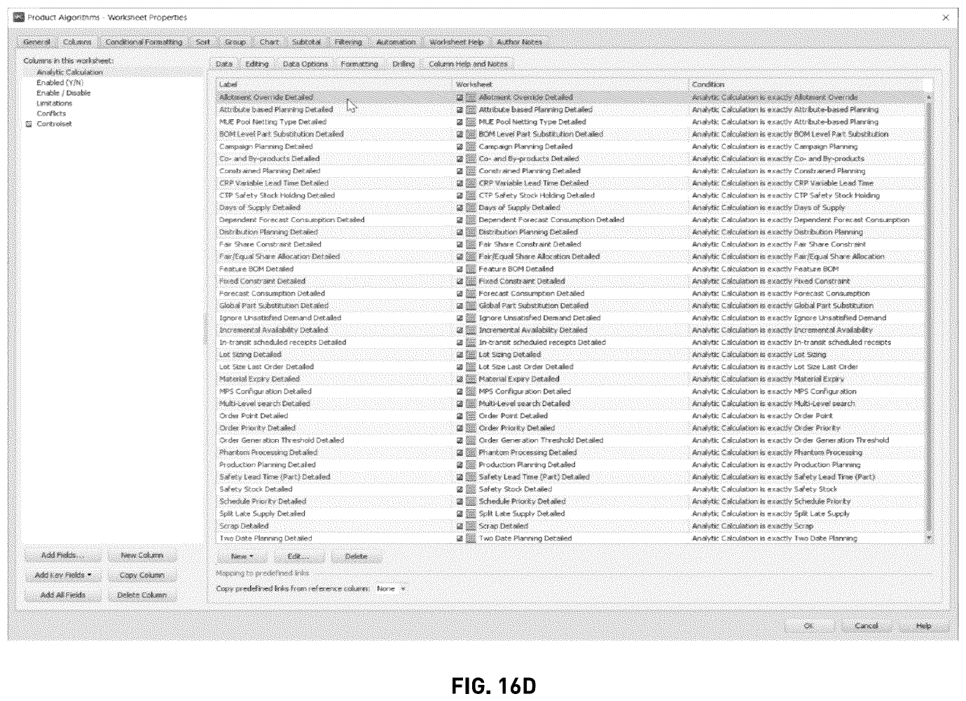

Next, at block 238, when a drill link is selected, detailed worksheets will be visible. This is further elaborated in FIG. 16A, FIG. 16B and FIG. 16C.

Next, at block 240, changes can be made by enable/disable of the algorithms.

FIG. 3A-FIG. 3D illustrate Table and Field details, in accordance with one embodiment. In FIG. 3A-FIG. 3D, an example 300 of table and field details of 36 base worksheets (corresponding to 36 algorithms) is listed. For each worksheet, listed are: a worksheet name 304, table name 306, fields 308 and expressions 310. That is, as shown in block 202 of FIG. 2A, a table-based base worksheet has been created with respect to 36 algorithms, in this example.

FIG. 4 illustrates composite worksheet details in accordance with one embodiment. This is part of block 204 in FIG. 2A, in which a composite worksheet is built by combining all of the base worksheets (created at block 202) using UNION join. Table 402 indicates the composite worksheet details, such as worksheet name 406 and fields 408. In 404 highlighted are: the name 410 of the composite worksheet; and the worksheets 412 that are combined to provide the composite worksheet . . . .

FIG. 5 illustrates creation of a new custom table, in accordance with one embodiment. The creation of the new custom table corresponds to block 206 in FIG. 2A. The name of the custom table is “ProductAlgorithms” (item 502), and it has been created by making one or more data model changes. In FIG. 5, the fields 504 for the new table are “Name”, “Enable/Disable” and “IsEnabled”.

FIG. 6A-FIG. 6D illustrate creation of a custom table in accordance with one embodiment. The creation of the new custom table corresponds to block 206 in FIG. 2A. In FIG. 6A, properties 602 of the custom table are visible, such as the table name 604 (“ProductAlgorithms”) and the name space 606 (“User”). FIG. 6B-FIG. 6D illustrate the creation of three fields, Name, EnableDisable, IsEnabled, in the custom table shown in FIG. 6A.

FIG. 6B illustrates creation of a first field in accordance with one embodiment. In this example, the table consists of 3 fields: Name, EnableDisable, IsEnabled. In FIG. 6B, creation of a field can be achieved by input of field properties at 608, which includes creation the field name 610 and field type 612. In FIG. 6B, the first field has the name “Name” and the field type is “String”.

FIG. 6C illustrates creation of a second field in accordance with one embodiment. In FIG. 6C, the creation the field “EnableDisable” is shown. In FIG. 6C, creation of the second field can be achieved by input of field properties at 608, which includes creation the field name 614 and field type 616. In FIG. 6C, the second field has the name “Enable/Disable” and the field type is “Boolean”.

FIG. 6D illustrates creation of a second field in accordance with one embodiment. In FIG. 6D, the creation the field “IsEnabled” is shown. In FIG. 6D creation of the second field can be achieved by input of field properties at 608, which includes creation the field name 618 and field type 616. In FIG. 6D, the third field has the name “IsEnabled” and the field type is “String”.

FIG. 7 illustrates creation of a new worksheet based on a custom table, in accordance with one embodiment. FIG. 7 is an embodiment of block 208 shown in FIG. 2A. In FIG. 7, a new worksheet 710 ‘UPD: Product Algorithms’ is created for data update. This worksheet is based on custom table “ProductAlgorithms”, as defined in FIG. 5. In the Automation tab 704, the update action is selected at 706. It gets source data from composite worksheet ‘Existing Product Analytics Status’, as selected at 708.

FIG. 8A-FIG. 8H are an embodiment of block 210 in FIG. 2A. FIG. 8A illustrates creation of a lookup worksheet in accordance with one embodiment. The worksheet ‘LKP: Product Algorithms’ 804 is created to lookup the analytics conditions. In lookup, the source worksheet should have grouped data so that the grouping condition 802 is maintained.

FIG. 8B-FIG. 8H illustrate a table of modification worksheet entries of the 36 worksheets illustrated in FIG. 3A-FIG. 3D. As an example in FIG. 8B, the worksheet number 1 (items 808) has the worksheet name “MOD: Allotment Override” (item 810); the term “MOD” refers to modification of the original worksheet entitled “Allotment Override”. In FIG. 8B, there are now four fields 812, and corresponding four expressions 310, for this modified worksheet. Compare this with original the worksheet number 1 (items 808) has the worksheet name “MOD: Allotment Override” (item 810); the term “MOD” refers to modification of the original worksheet entitled “Allotment Override”. In FIG. 8B, there are now four fields 812, and corresponding four expressions 814 for this modified worksheet. Compare this to the original worksheet number 1 (worksheet name “Allotment Override”) in FIG. 3A. In FIG. 3A, the original worksheet has two fields and corresponding two expressions.

A similar analysis can be made with respect to the remaining 35 modified worksheets (in FIG. 8B-FIG. 8H) compared to the corresponding original worksheets in FIG. 3A-FIG. 3D).

FIG. 9A-FIG. 9C illustrate an embodiment of blocks 210-220 shown in FIG. 2A-FIG. 2B. FIG. 9A illustrates modification of worksheets in accordance with one embodiment. Automation action Modify (item 902) is selected in all the 36 modification worksheets and all these automation worksheets are added in a command.

FIG. 9B illustrates saving data changes in a Product Algorithms worksheet in accordance with one embodiment. On saving data changes in Product Algorithms worksheet, the Modify command can automatically run on the background and do the configuration changes by itself.

FIG. 9C-FIG. 9G illustrate a table of conditionally hidden Drill to Detail worksheet entries. All of the conditionally hidden worksheets are only visible when the specific analytics are selected.

FIG. 10 illustrates an embodiment of block 222 in FIG. 2B. FIG. 10 illustrates an action button for hiding a visible drill worksheet in accordance with one embodiment. To hide a visible worksheet, an action button, item 1002, named Hide Drill Worksheets can be provided in the worksheet toolbar; once it is selected, all the detailed worksheet becomes hidden.

FIG. 11A illustrates an embodiment of block 224 in FIG. 2B. FIG. 11A illustrates a Limitation Count Worksheet in accordance with one embodiment. In FIG. 11A, the SRC: Limitation Count worksheet is a composite of two component worksheets: All Product Algorithms and Product Algorithms=Y.

FIG. 11B illustrates an embodiment of block 226 in FIG. 2B. FIG. 11B illustrates properties of a Limitation Count Worksheet in accordance with one embodiment. In FIG. 11B, the SRC: Limitation Count worksheet is a composite two component worksheet: All Product Algorithms and Product Algorithms=Y. The limitation column shows whether particular analytics has limitation or not.

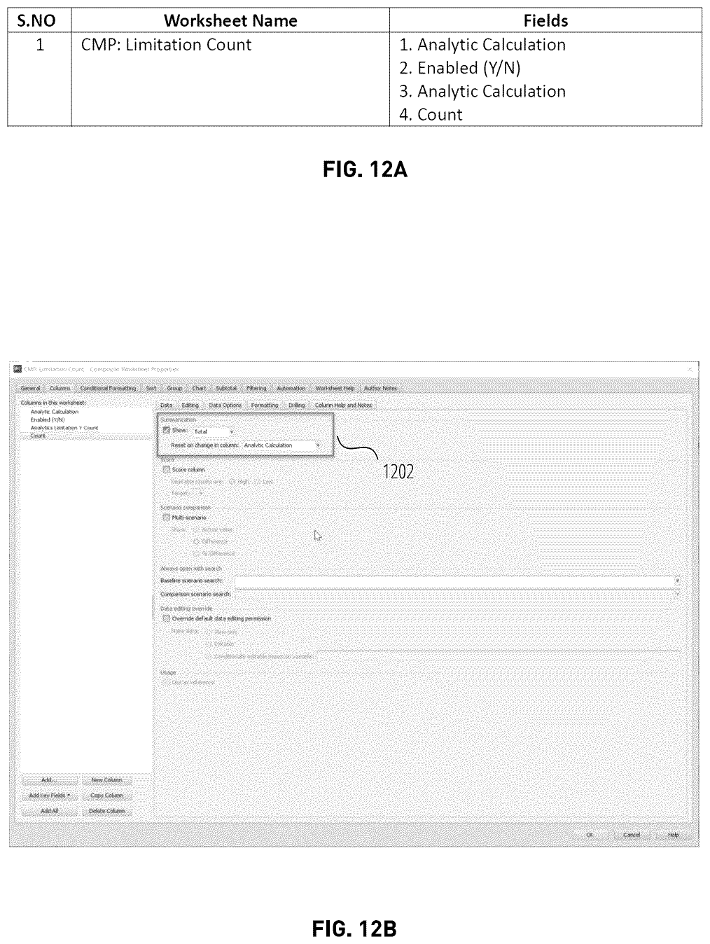

FIG. 12A illustrates a CMP: Limitation Count Worksheet in accordance with one embodiment.

FIG. 12B properties of a CMP: Limitation Count Worksheet in accordance with one embodiment. The CMP: Limitation Count worksheet shows the total number of limitations, 1202, for each analytics.

FIG. 13A illustrates an embodiment of block 230 in FIG. 2B. FIG. 13A illustrates an SRC: Conflicts Count Worksheet in accordance with one embodiment. The SRC: Conflicts Count worksheet is also a composite of two component worksheets: All Product Algorithms and Product Algorithms=Y. The conflicts column shows whether a particular analytic has conflicts or not.

FIG. 13B-FIG. 13C illustrate an embodiment of block 232 in FIG. 2C. FIG. 13B illustrates a CMP: Conflicts Count Worksheet in accordance with one embodiment. The CMP: Conflicts Count worksheet shows the number of Conflicts for each analytics.

FIG. 13C illustrates properties of an SRC: Conflicts Count Worksheet in accordance with one embodiment.

FIG. 14A illustrates an embodiment of block 228 in FIG. 2B, while FIG. 14B illustrates an embodiment of block 234 in FIG. 2C. FIG. 14A illustrates a Limitations Worksheet in accordance with one embodiment. Due to filtering condition in the Limitations worksheet, it only displays those analytics which have limitations with the other enabled analytics. This worksheet is conditionally hidden so it is visible only when selected.

FIG. 14B illustrates properties of a Limitations Worksheet in accordance with one embodiment. Due to filtering condition in the Limitations worksheet, it only displays those analytics which have limitations with the other enabled analytics. This worksheet is conditionally hidden so it is visible only when selected.

FIG. 15AA-FIG. 15B illustrate an embodiment of block 236 in FIG. 2C. FIG. 15A illustrates a Conflicts Worksheet in accordance with one embodiment. Due to the filtering condition in the Conflicts worksheet, it only displays the analytics which has conflicts with the other enabled analytics. This worksheet is conditionally hidden so it is visible only when selected.

FIG. 15B illustrates properties of a Conflicts Worksheet in accordance with one embodiment. Due to the filtering condition in the Conflicts worksheet, it only displays the analytics which has conflicts with the other enabled analytics. This worksheet is conditionally hidden so it is visible only when selected.

FIG. 16A-FIG. 16D illustrate an embodiment of block 238 in FIG. 2C. FIG. 16A illustrates a User Interface Worksheet in accordance with one embodiment. The User Interface Worksheet is named “Product Algorithms” in FIG. 16A.

FIG. 16B illustrates properties of a User Interface Worksheet in accordance with one embodiment. The User Interface Worksheet is named “Product Algorithms” in FIG. 16B. Conditional formatting can be applied on the user interface worksheet. For example, if a particular analytic is enabled, then it may be highlighted in a first color 1602 (green, for example, in FIG. 16B); and if it has limitation, it may be highlighted in a second color 1604 (yellow, for example, in FIG. 16B).

FIG. 16C illustrates a User Interface Worksheet in accordance with one embodiment. The User Interface Worksheet is named “Product Algorithms” in FIG. 16C. A user can have an option to see a detailed worksheet by clicking a specific analytic calculation. In FIG. 16C, the specific analytic calculation is “Allotment Override”, which has 1 limitation and 0 conflicts.

FIG. 16D illustrates properties of a User Interface Worksheet in accordance with one embodiment. The User Interface Worksheet is named “Product Algorithms” in FIG. 16D. As an example, all of above mentioned 36 conditionally hidden drill to detailed worksheets (in FIG. 9C-FIG. 9G) are added as hyperlinks with each algorithm.

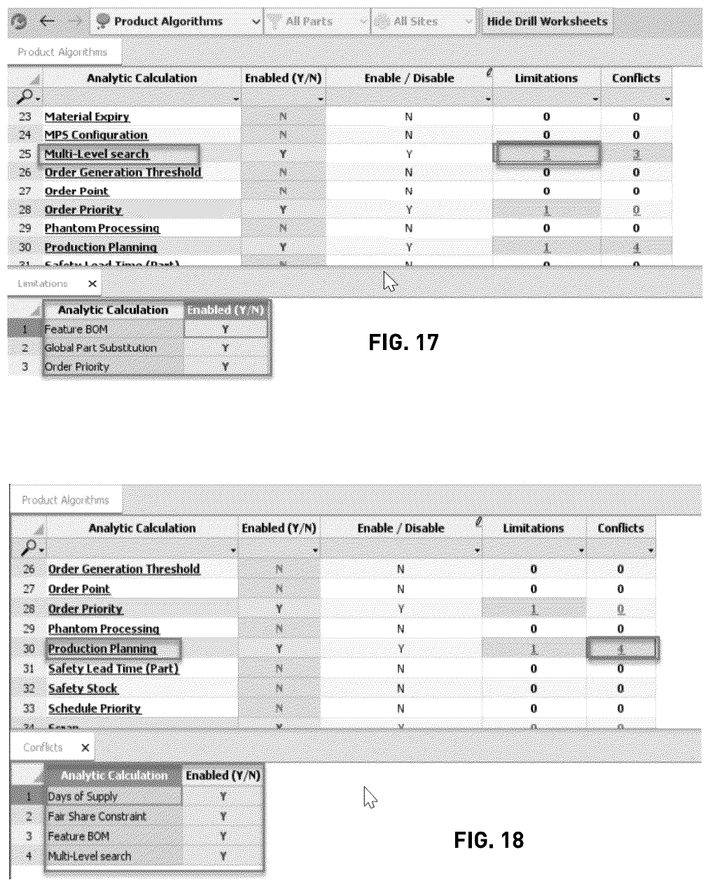

FIG. 17 illustrates an aspect of a User Interface Worksheet in accordance with one embodiment. The User Interface Worksheet is named “Product Algorithms” in FIG. 17. A user can see the number of limitations count for a specific analytic, as well as details related to the analytic.

In FIG. 17, the analytic “Multi-Level Search” is selected, showing 3 limitations and 3 conflicts. The 3 limitations are the analytics “Feature BOM”, “Global Part Substitution” and “Order Priority”.

FIG. 18 illustrates an aspect of a User Interface Worksheet in accordance with one embodiment. The User Interface Worksheet is named “Product Algorithms” in FIG. 18. Similarly, a user can also see the number of conflicts count for a specific analytic, as well as details related to the analytic.

In FIG. 18, the analytic “Production Planning” is selected, showing 1 limitation and 4 conflicts. The 4 conflicts are the analytics “Days of Supply”, “Fair Share Constraint”, “Feature BOM”, and “Multi-level Search”.

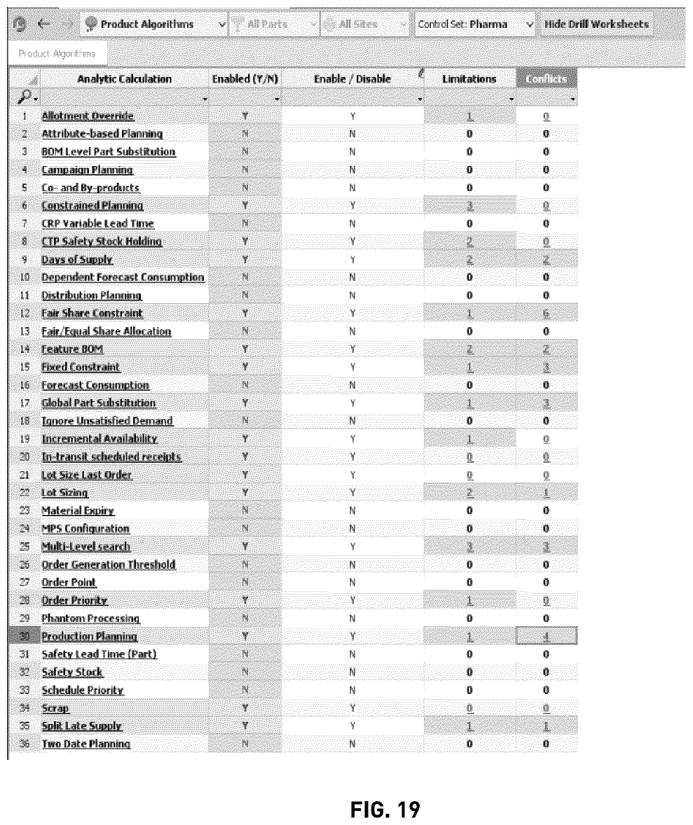

FIG. 19 illustrates an aspect of a User Interface Worksheet in accordance with one embodiment. The User Interface Worksheet is named “Product Algorithms” in FIG. 19. In the example shown in FIG. 19, the total number of analytics is 36; the configuration, limitations and conflicts of each are shown in the user interface.

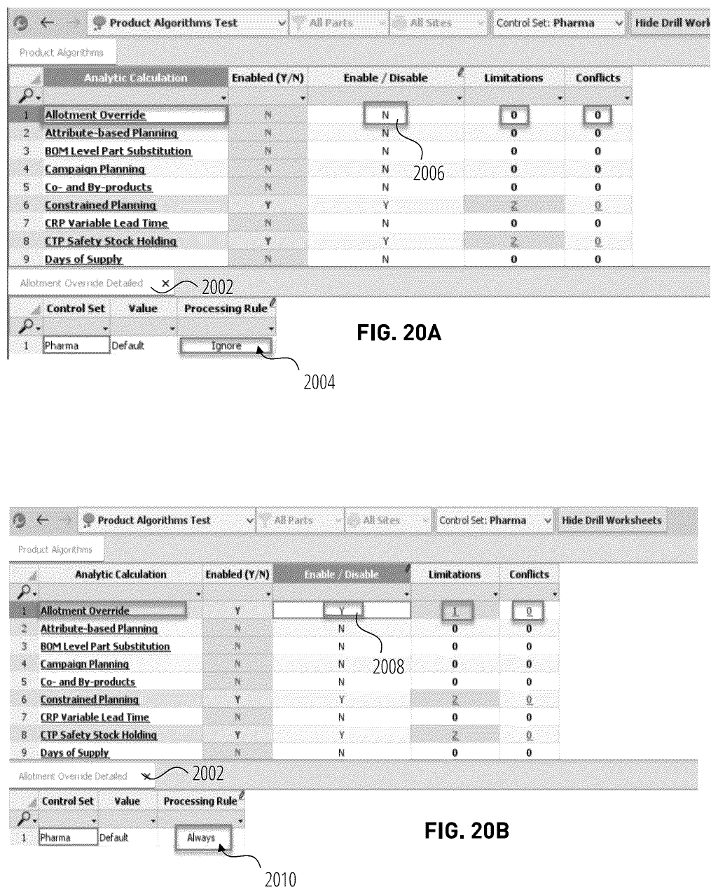

FIG. 20A illustrates an aspect of a User Interface Worksheet in accordance with one embodiment. The User Interface Worksheet is named “Product Algorithms” in FIG. 20A. When Allotment Override is disabled (that is, when the enabled configuration is ‘N’-see item 2006), the limitations count and conflicts count are each ‘0’. The Allotment Override Detailed worksheet (2002) indicates that the Processing Rule is ‘Ignored’ (item 2004).

FIG. 20B illustrates a further aspect of the User Interface Worksheet shown in FIG. 20A, in accordance with one embodiment. Now, Allotment Override is enabled (that is, when the enabled configuration is ‘Y’-see item 2008),. The limitations count and the conflicts count have each been updated (the limitations count is now ‘1’, while the conflicts count remains at ‘0’). The Allotment Override Detailed worksheet 2002 indicates that the Processing Rule has been changed to ‘Always’ (see item 2010). On saving data, all of these changes happen through automation.

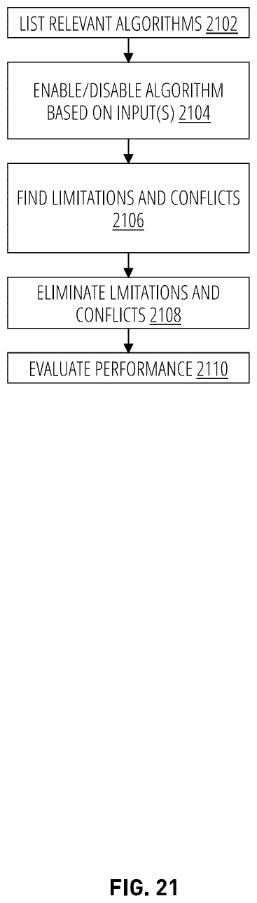

FIG. 21 illustrates a block diagram for using a user interface in accordance with one embodiment.

On a user interface, algorithms that are related to a particular scope of business may be listed at block 2102. As an example, analytics may be performed on different core business areas, such as automobile, pharma, aviation, and so on. Each core area can use distinct algorithms. As an example, algorithms that relate to expiry dates are not used in automobile industries, since automobile parts do not expire. However, such algorithms are used in the pharmaceutical industry; such classes of algorithms would be listed at a user interface where a user is analyzing a pharmaceutical industry issue. Thus, in general, in an embodiment of a user interface worksheet, all algorithms that are related to a particular business can be gathered and listed in the central user interface worksheet.

[symbol]

A user may then provide one or more inputs to either enable or disable a given algorithm at block 2104. As an example, a user can decide to disable one or more algorithms related to expiry dates, if such an analysis is not required for the purposes of the user. In another example, it may not be necessary to run all listed algorithms in the background, as this may affect performance negatively—in such a case, a user may choose to disable one or more algorithms to improve performance. As use cases change, the user can use the central worksheet user-interface to enable or disable algorithms. Prior to this centralized worksheet, a user would be required to find which disparate worksheets to locate, navigate to those worksheets, find the appropriate algorithms, and then manually enable or disable a particular algorithm.

For a given algorithm, limitations and conflicts in relation to other algorithms, are searched at block 2106. In a platform, there can be hundreds, thousands (if not more) of algorithms. All of these algorithms cannot be activated (or enabled) all at once. For one, this may affect the performance of executing on the platform. For another, one algorithm may have an impact on one or more other algorithms. As an example, there may be a case where two algorithms cannot be enabled at the same time. The centralized user-interface worksheet shows what limitations and conflicts a given enabled algorithm has with other algorithms. Such limitations and conflict can be eliminated at block 2108, for example, by disabling one or more related algorithms, using the centralized user-interface worksheet.

Finally, at block 2110, performance of the control analytics can be evaluated, as expected by the user.

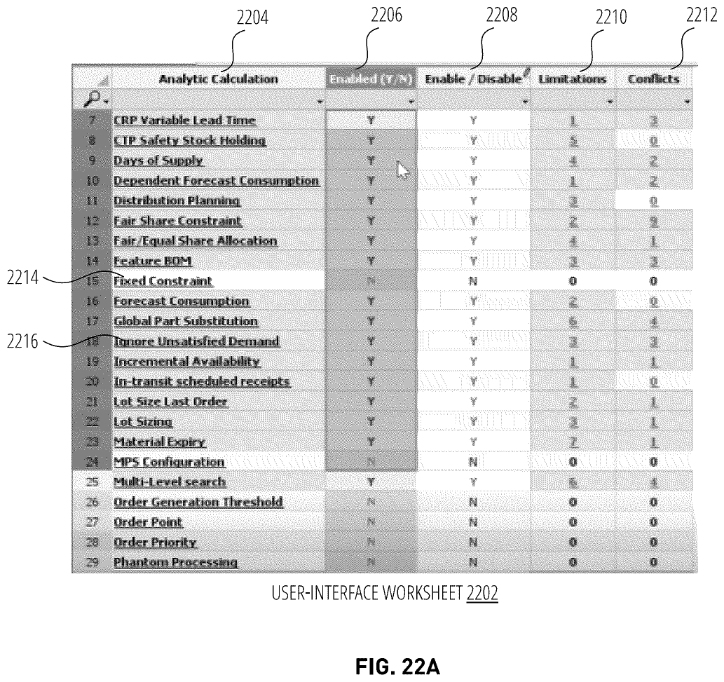

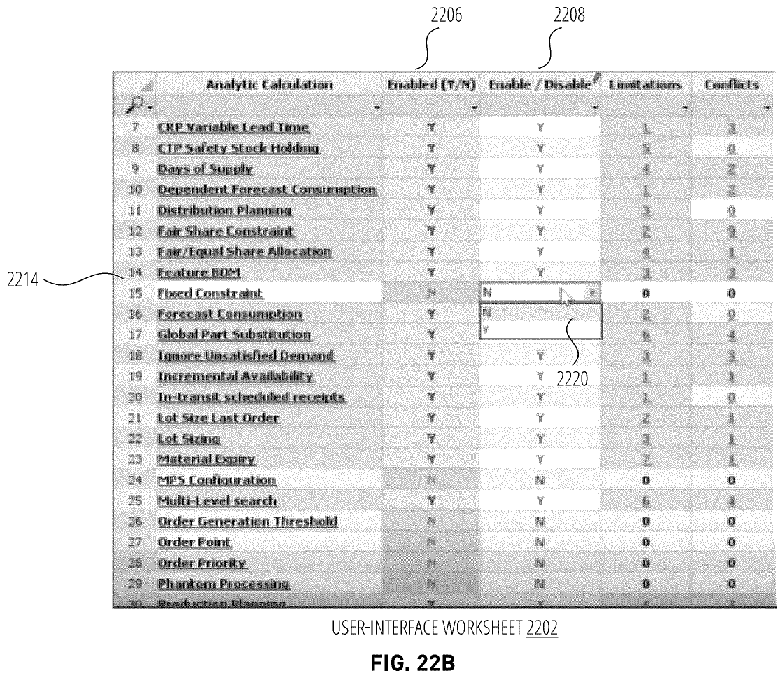

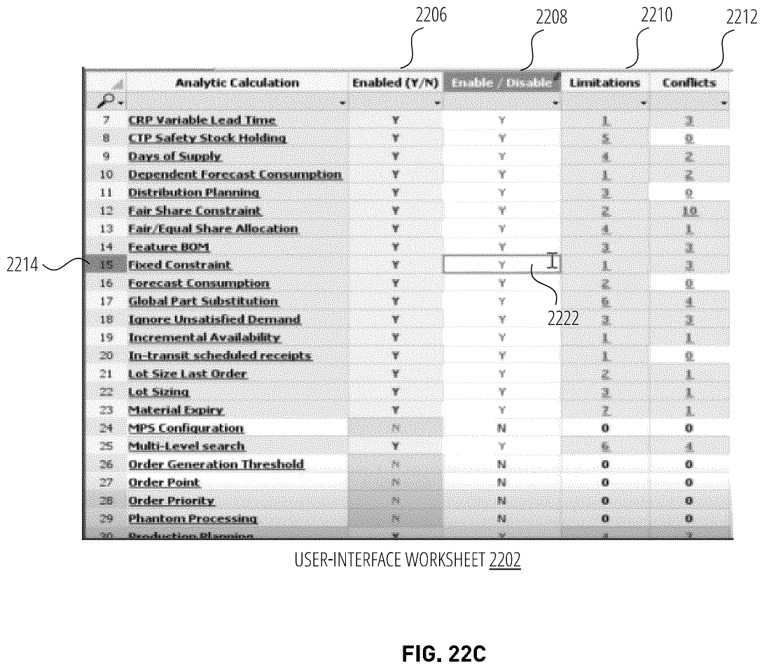

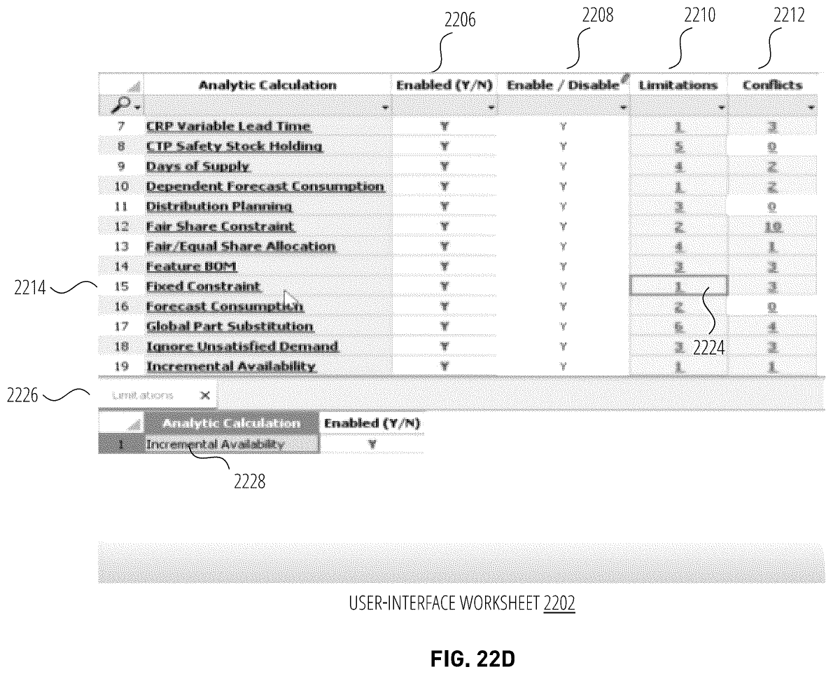

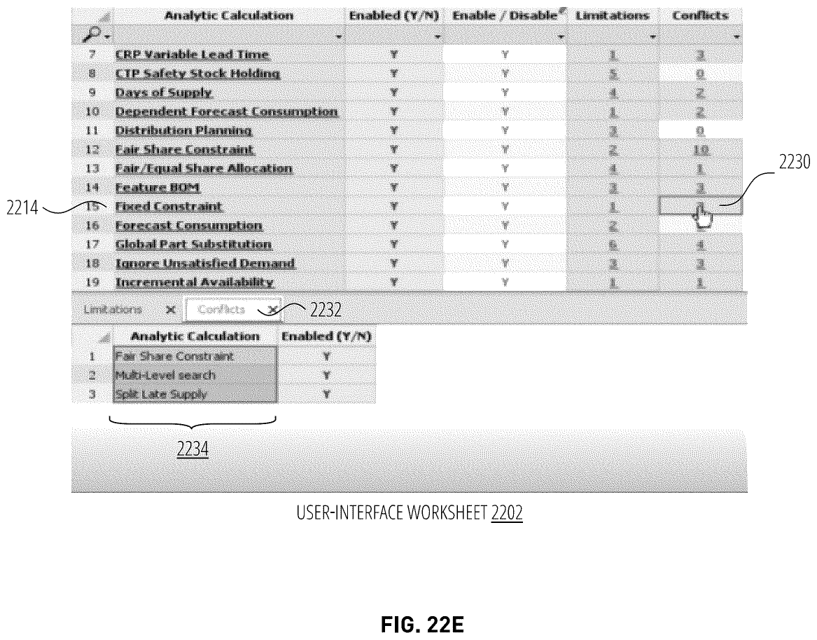

FIG. 22A illustrates a user-interface worksheet 2202 in accordance with one embodiment. In this embodiment, there are five columns.

Column 2204, entitled ‘Analytic Calculation’ lists each algorithm used to calculate analytics for a particular industry. While the algorithms are listed in alphabetical order, it is understood that the algorithms can be listed in any order.

Column 2206, entitled ‘Enabled (Y/N)’ indicates whether a given algorithm is enabled or disabled; its entry cannot be directly modified. On the other hand, Column 2208, entitled ‘Enable/Disable’ allows a user to directly modify the activation status of a given algorithm. Note that the entry of column 2208 is identical to that of column 2206.

Column 2210, entitled ‘Limitations’ lists the number of limitations associated with a given algorithm, and links to those algorithms which are limited, or limit, the given algorithm. For example, a limitation for other algorithms indicates a restriction of some activities for those other algorithms, in that the given algorithm will not allow all activities for the other algorithms.

Column 2212, entitled ‘Conflicts’ lists the number of conflicts associated with a given column, and links to those algorithms which are in conflict with the given algorithm. Algorithms that are in conflict with each cannot both be enabled at the same time.

As an example, the algorithm “Fixed Constraint” (2214) is not enabled (‘N’ at column 2206). Thus it is not enabled (‘N’) at column 2208, and can be enabled. Since this algorithm is disabled, there is no information regarding any limitations (‘O’ at column 2210) or conflicts (‘0’ at column 2212) it has with other algorithms in the list.

As another example, the algorithm “Ignore Unsatisfied Demands” (2216) is enabled (‘Y’ at column 2206). Thus it is enabled (‘NY’) at column 2208. Since this algorithm is enabled, there is information regarding any limitations (‘3’ at column 2210) and conflicts (‘3’ at column 2212) it has with other algorithms in the list.

FIG. 22B illustrates modification of the user-interface worksheet 2202 shown in FIG. 22A, in accordance with one embodiment.

Here, the algorithm “Fixed Constraint” (2214) is not enabled (‘N’ at column 2206). Thus it is not enabled (‘N’) at column 2208, and can be enabled, as shown by the toggle box 2238, which allows a user to change the status of “Fixed Constraint” (2214) from disabled (‘N’) at column 2208, to enabled (‘Y’).

FIG. 22C illustrates modification of the user-interface worksheet 2202 shown in FIG. 22A, in accordance with one embodiment.

User-interface worksheet 2202 now shows the activation status of “Fixed Constraint” (2214) after changing it from disabled ((‘N’) at column 2208) to enabled (‘Y’) as shown by 2222, at column 2208. The algorithm “Fixed Constraint” (2214) is now enabled (‘Y’ at column 2206) and enabled (‘Y’) at column 2208. Since this algorithm is enabled, there is information regarding any limitations (‘l’ at column 2210) and conflicts (‘3’ at column 2212) it has with other algorithms in the list.

FIG. 22D illustrates the user-interface worksheet 2202 shown in FIG. 22C, in accordance with one embodiment.

On user-interface worksheet 2202, a user has clicked on ‘1’, the number of limitations for the algorithm “Fixed Constraint” 2214. This results in a pop-up 2226, which indicates which algorithms are limited by “Fixed Constraint” 2214, and the respective activation status of each. Here, the lone algorithm that is limited by “Fixed Constraint” 2214, is the algorithm “Incremental Availability” 2228, which is enabled (as indicated by ‘Y’). Therefore, user-interface worksheet 2202 indicates that the algorithm “Incremental Availability” 2228 cannot execute everything on its own since it has limitations with respect to the algorithm “Fixed Constraint” 2214.

FIG. 22E illustrates the user-interface worksheet 2202 shown in FIG. 22C and FIG. 22D, in accordance with one embodiment.

On user-interface worksheet 2202, a user has clicked on ‘3’, the number of limitations (2230) for the algorithm “Fixed Constraint” 2214. This results in a pop-up 2232, which indicates which algorithms (2234) are in conflict with “Fixed Constraint” 2214, and the respective activation status of each.

Here, the three algorithms that are in conflict with “Fixed Constraint” 2214, are: the algorithm “Fair Share Constraint”, which is enabled (as indicated by ‘Y’); the algorithm “Multi-Level Search”, which is enabled (as indicated by ‘Y’); and the algorithm “Split Late Supply”, which is enabled (as indicated by ‘Y’).

Therefore, user-interface worksheet 2202 indicates that the algorithms “Fair Share Constraint”, “Multi-Level Search”, and “Split Late Supply”, cannot execute simultaneously with the algorithm “Fixed Constraint” 2214.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system comprising:
a processor; and
a memory storing instructions that, when executed by the processor, configure the system to:
create, by the processor, one or more table-based base worksheets for each analytic;
build, by the processor, a composite worksheet by combining all of the one or more table-based base worksheets;
create, by the processor, a new custom table with one or more requisite fields;
update, by the processor, the composite worksheet;
create, by the processor, a lookup worksheet;
create, by the processor, a respective modification worksheet for each analytic;
add, by the processor, all of the modification worksheets;
create, by the processor, a respective drill-to-detail worksheet for each analytic;
render, by the processor, each drill-to-detail worksheet conditionally hidden;
add, by the processor, all of the conditionally-hidden drill-to-detail worksheets;
create, by the processor, an action button to hide one or more detailed worksheets;
create, by the processor, a limitations-count worksheet;
count, by the processor, a number of limitations associated with each analytic;
create, by the processor, a limitations worksheet;
add, by the processor, the limitations worksheet to the composite worksheet;
create, by the processor, a conflicts-count worksheet;
count, by the processor, a number of conflicts associated with each analytic;
create, by the processor, a conflicts worksheet; and
add, by the processor, the conflicts worksheet to the composite worksheet.

2. The system of claim 1, wherein the lookup worksheet is created by grouping data.

3. The system of claim 1, wherein all of the modification worksheets are added in a single Run command.

4. The system of claim 1, wherein the limitations-count worksheet is created by applying one or more filter conditions.

5. The system of claim 1, wherein the conflicts-count worksheet is created by applying one or more filter conditions.

6. The system of claim 1, wherein when counting the number of limitations associated with each analytic, the system is further configured to:
take, by the processor, a composite of the limitations-count worksheet; and
enable, by the processor, summarization for a count column.

7. The system of claim 1, wherein when counting the number of conflicts associated with each analytic, the system is further configured to:
take, by the processor, a composite of the conflicts-count worksheet; and
enable, by the processor, summarization for a count column.

8. A non-transitory computer-readable storage medium, the computer-readable storage medium including instructions that when executed by a computer, cause the computer to:
create, by a processor, one or more table-based base worksheets for each analytic;
build, by the processor, a composite worksheet by combining all of the one or more table-based base worksheets;
create, by the processor, a new custom table with one or more requisite fields;
update, by the processor, the composite worksheet;
create, by the processor, a lookup worksheet;
create, by the processor, a respective modification worksheet for each analytic;
add, by the processor, all of the modification worksheets;
create, by the processor, a respective drill-to-detail worksheet for each analytic;
render, by the processor, each drill-to-detail worksheet conditionally hidden;
add, by the processor, all of the conditionally-hidden drill-to-detail worksheets;
create, by the processor, an action button to hide one or more detailed worksheets;
create, by the processor, a limitations-count worksheet;
count, by the processor, a number of limitations associated with each analytic;
create, by the processor, a limitations worksheet;
add, by the processor, the limitations worksheet to the composite worksheet;
create, by the processor, a conflicts-count worksheet;
count, by the processor, a number of conflicts associated with each analytic;
create, by the processor, a conflicts worksheet; and
add, by the processor, the conflicts worksheet to the composite worksheet.

9. The non-transitory computer-readable storage medium of claim 8, wherein the lookup worksheet is created by grouping data.

10. The non-transitory computer-readable storage medium of claim 8, wherein all of the modification worksheets are added in a single Run command.

11. The non-transitory computer-readable storage medium of claim 8, wherein the limitations-count worksheet is created by applying one or more filter conditions.

12. The non-transitory computer-readable storage medium of claim 8, wherein the conflicts-count worksheet is created by applying one or more filter conditions.

13. The non-transitory computer-readable storage medium of claim 8, wherein when counting the number of limitations associated with each analytic, the computer is further configured to:
take, by the processor, a composite of the limitations-count worksheet; and
enable, by the processor, summarization for a count column.

14. The non-transitory computer-readable storage medium of claim 8, wherein when counting the number of conflicts associated with each analytic, the computer is further configured to:
take, by the processor, a composite of the conflicts-count worksheet; and
enable, by the processor, summarization for a count column.

15. A computer-implemented method for constructing a user interface, the method comprising:
creating, by a processor, one or more table-based base worksheets for each analytic;
building, by the processor, a composite worksheet by combining all of the one or more table-based base worksheets;
creating, by the processor, a new custom table with one or more requisite fields;
updating, by the processor, the composite worksheet;
creating, by the processor, a lookup worksheet;
creating, by the processor, a respective modification worksheet for each analytic;
adding, by the processor, all of the modification worksheets;
creating, by the processor, a respective drill-to-detail worksheet for each analytic;
rendering, by the processor, each drill-to-detail worksheet conditionally hidden;
adding, by the processor, all of the conditionally-hidden drill-to-detail worksheets;
creating, by the processor, an action button to hide one or more detailed worksheets;
creating, by the processor, a limitations-count worksheet;
counting, by the processor, a number of limitations associated with each analytic;
creating, by the processor, a limitations worksheet;
adding, by the processor, the limitations worksheet to the composite worksheet;
creating, by the processor, a conflicts-count worksheet;
counting, by the processor, a number of conflicts associated with each analytic;
creating, by the processor, a conflicts worksheet; and
adding, by the processor, the conflicts worksheet to the composite worksheet.

16. The computer-implemented method of claim 15, wherein the lookup worksheet is created by grouping data.

17. The computer-implemented method of claim 15, wherein all of the modification worksheets are added in a single Run command.

18. The computer-implemented method of claim 15, wherein the limitations-count worksheet is created by applying one or more filter conditions.

19. The computer-implemented method of claim 15, wherein the conflicts-count worksheet is created by applying one or more filter conditions.

20. The computer-implemented method of claim 15, wherein when counting the number of limitations associated with each analytic, the method further comprises:
taking, by the processor, a composite of the limitations-count worksheet; and
enabling, by the processor, summarization for a count column.

21. The computer-implemented method of claim 15, wherein when counting the number of conflicts associated with each analytic, the method further comprises:
taking, by the processor, a composite of the conflicts-count worksheet; and
enabling, by the processor, summarization for a count column.
